(19) United States
(12) Patent Application Publication
(10) Pub. No.: US 2003/0137989 A1
(43) Pub. Date: Jul. 24, 2003

(54) Communication method, communication apparatus and communication system

(76) Inventor: Tetsuya Nagai, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/284,192

(22) Filed: Oct. 31, 2002

(30) Foreign Application Priority Data
Nov. 2, 2001 (JP) 2001-338368

(51) Int. Cl. H04L 12/403

(52) U.S. Cl. 370/455

(57) ABSTRACT

In a communication apparatus for transmitting a packet between plural communication apparatus, an inputted digital signal is converted into a signal having a form suitable for transmission and is sent out to the transmission line, and a check is made as to whether or not a signal exists on the transmission line for, if the signal exists thereon, issuing a busy signal and receive the signal existing thereon for converting the signal into a digital signal. In the communication apparatus, a priority observation unit observes the correspondence between a physical priority and application priority of a packet flowing on the transmission line on the basis of the converted digital signal, and a priority conversion unit accumulates the results of observations by the priority observation unit at intervals of given period of time to produce/update a conversion table between a physical priority and an application priority for obtaining a corresponding physical priority on the basis of a packet application priority inputted together with transmission packet data from the external. Moreover, when a timing of a priority time slot corresponding to the physical priority notified from the priority conversion unit is reached, a buffer unit sends out retained transmission packet data for transmission. This can effectively utilizing a transmission line while carrying out communication according to priority.

### BACKGROUND OF THE INVENTION

1) Field of the Invention

The present invention relates to a communication method, communication apparatus and communication system designed to transmit packets according to a carrier sense multiple access with a collision detection function (which will hereinafter be referred to as a “CSMA/CD”).

2) Description of the Related Art

The CSMA/CD system is provided in IEEE802.3, and has come into widespread use in local area networks. FIG. 29 is an illustration of the relationship between a conventional communication apparatus according to a CSMA/CD system and a transmission line. In FIG. 29, reference numeral 1 denotes a transmission line and numerals 25.1 to 25.4 signify communication apparatus, respectively. Each of the communication apparatus 25.1 to 25.4 monitors a using state of the transmission line 1, and when the transmission line 1 is used by another communication apparatus, that is, when a signal exists on the transmission line 1, does not initiate the transmission even if a transmission request is made to itself and transmits its own packets after the completion of the former communication.

In addition, if a plurality of communication apparatus start the communications at the same time, the collision between packets occurs to make normal communication difficult. In the case of the occurrence of the collision, these communication apparatus cease the transmission and then tries the re-transmission after waiting a random time.

As mentioned above, the CSMA/CD system enables each of communication apparatus to use the transmission line 1 fairly. However, recently, it is considered that information with different priorities are flowed on this transmission 1. For example, assuming that computer data and voice information are handled, although the computer data allows delay in some degree, desirable consideration is less delay of the voice information. That is, there is a requirement for the transmission of voice information with a high priority (precedence).

FIG. 30 is an illustration useful for explaining one of conventional methods of meeting this requirement. This method provides five different priorities.

Upon the completion of transmission of one packet, five time slots PTS1 to PTS5 are set thereafter. Each of communication apparatus can learn the priority of its own packet through the contents of that information. In this example, the voice information has the second priority while the computer data has the fifth priority. The packet having the second priority can be transmitted from the time slot PTS2, while the transmission of the packet having the fifth priority must wait for the time slot PTS5.

Secondly, a description will be given hereinbelow of an operation to be conducted in this method.

Let it be assumed that a request Txrequest for transmission of a packet having the fifth priority from the communication apparatus 25.1 occurs during the previous packet transmission and a request TXrequest for transmission of a packet having the second priority from the communication apparatus 25.2 then occurs. Irrespective of the earlier occurrence of the transmission request from the communication apparatus 25.1, because of the packet transmission from the time slot PTS5, the communication apparatus 25.2 can start the packet transmission earlier. Since the transmission line 1 was already used at the time of the transmission from the time slot PTS5, the communication apparatus 25.1 encounters the difficulty of transmission of its own packet. Thus, as mentioned above, even the conventional method can avoid the collision and can preferentially transmit a packet having a high priority.

However, in the case of applications in which only packets having a low priority (for example, the fifth priority) flow, the above-described conventional communication apparatus must wait until the time slot PTS5 is reached for the start of transmission, and it is remote from the effective utilization of the transmission line.

### SUMMARY OF THE INVENTION

The present invention has been developed with a view to eliminating the above-mentioned conventional problem, and it is therefore an object of the invention to provide a communication method, communication apparatus and communication system capable of utilizing a transmission line effectively while enabling packet communication according to priority (precedence).

For this purpose, in accordance with the present invention, there is provided a communication method of transmitting packets according to a carrier sense multiple access system with a collision detection function between plural communication apparatus each connected to a transmission line of a logically substantial bus type, comprising setting N (N represents an integer which is two or more) application priorities specified from the external and N physical priorities to be used at actual transmission to the transmission line where 1 signifies the highest priority and N signifies the lowest priority, setting N priority time slots after a packet comes to an end on the transmission line where the time slots are taken as PTS1, PTS2, . . . , PTSN in latening time sequence so that a packet having a physical priority=m (1≦m≦N) has a transmission right on and after a time slot PTSm, carrying out an observation of the application priority and physical priority of a packet flowing on the transmission line for a given period of time for seizing the correspondence between the application priority and the physical priority, setting, as a physical priority for a packet to be transmitted from one apparatus, a physical priority lower by one rank than a physical priority of a packet having an application priority higher than an application priority of the packet to be transmitted from the one apparatus, setting the physical priority at 1 when a packet having an application priority higher than the application priority of the packet to be transmitted from the one apparatus does not exist on the transmission line, and updating a conversion rule for the physical priority and the application priority at intervals of the given time period of the priority observation. This provides an excellent communication method capable of effectively utilizing the transmission line while enabling the communication according to packet priority.

In addition, in accordance with the present invention, there is provided a communication apparatus comprising a transmission unit having a function to convert an inputted digital signal into a signal having a form suitable for transmission and to send out the signal to a transmission line, a reception unit having a function to check whether or not a signal exists on the transmission line and to, if the signal exists thereon, issue a busy signal and receive that signal for converting it into a digital signal, a priority observation unit for observing the correspondence between a physical priority and application priority of a packet flowing on the transmission line on the basis of the digital signal outputted from the reception unit, a priority conversion unit for accumulating the results of observations by the priority observation unit at intervals of given period of time to produce and update a conversion table between a physical priority and an application priority for obtaining and outputting a physical priority corresponding to a packet application priority inputted together with transmission packet data from the external, a buffer unit having a function to temporarily retain transmission packet data, and a timing generation unit for detecting that a packet comes to an end on the transmission line and that the busy signal is non-active and for, when a timing of a priority time slot corresponding to the physical priority notified from the priority conversion unit is reached after the time that the packet comes to an end on the transmission line, sending a transmission start signal to the buffer unit so that the buffer unit sends out the retained transmission packet data to the transmission unit in accordance with the transmission start signal therefrom. This provides an excellent communication apparatus capable of effectively utilizing the transmission line while enabling the packet communication according to priority.

Moreover, the aforesaid communication apparatus is connected to a transmission line of a logically substantial bus type. This provides an excellent communication system capable of effectively utilizing the transmission line while enabling the packet communication according to priority.

Furthermore, in accordance with the present invention, there is provided a communication method of transmitting packets according to a carrier sense multiple access system with a collision detection function between plural communication apparatus each connected to a transmission line of a logically substantial bus type, comprising setting N (N represents an integer which is two or more) application priorities specified from the external and N physical priorities to be used at actual transmission to the transmission line where 1 signifies the highest priority and N signifies the lowest priority, setting N priority time slots after a packet comes to an end on the transmission line where the time slots are taken as PTS1, PTS2, . . . , PTSN in latening time sequence so that a packet having a physical priority=m (1≦m≦N) has a transmission right on and after a time slot PTSm, making one master communication apparatus carry out an observation of the application priority and physical priority of a packet flowing on the transmission line for a given period of time for seizing the correspondence between the application priority and the physical priority, and broadcasting information on conversion from the application priority to the physical priority to the other or remaining communication apparatus. This provides an excellent communication method capable of effectively utilizing the transmission line while enabling the communication according to packet priority.

Still furthermore, in accordance with the present invention, there is provided a communication apparatus comprising a transmission unit having a function to convert an inputted digital signal into a signal having a form suitable for transmission and to send out the signal to a transmission line, a reception unit having a function to check whether or not a signal exists on the transmission line and to, if the signal exists thereon, issue a busy signal and receive that signal for converting it into a digital signal, a priority observation unit for observing the correspondence between a physical priority and application priority of a packet flowing on the transmission line on the basis of the digital signal outputted from the reception unit, a priority conversion unit for accumulating the results of observations by the priority observation unit at intervals of given period of time to produce and update a conversion table between a physical priority and an application priority for obtaining a physical priority corresponding to a packet application priority inputted together with transmission packet data from the external and outputting it to a timing generation unit, a buffer unit having a function to temporarily retain transmission packet data, and a conversion information transmission unit having a function to convert information on conversion between the physical priority and the application priority into a packet data form for transferring it to the buffer unit, with, when a packet to be transmitted exists, the data of the packet being inputted to the buffer unit, and the priority conversion unit obtaining the physical priority corresponding to the application priority of the packet to notify the obtained physical priority to the timing generation unit, and if a packet comes to an end on the transmission line and the busy signal becomes non-active, the timing generation unit detecting this condition and sending a transmission start signal to the buffer unit when a timing of a priority time slot (PTS) corresponding to the physical priority notified from the priority conversion unit is reached after the time that the packet comes to an end on the transmission line, and the buffer unit sending out the retained transmission packet data to the transmission unit in response to the transmission start signal, and the conversion information transmission unit transferring the contents of the conversion table at every conversion table production/updating to the buffer unit of each of other communication apparatus in the form of a packet. This provides an excellent communication apparatus capable of effectively utilizing the transmission line while enabling the packet communication according to priority.

Moreover, in accordance with the present invention, there is provided a communication method of transmitting packets according to a carrier sense multiple access system with a collision detection function between plural communication apparatus each connected to a transmission line of a logically substantial bus type, comprising setting N (N represents an integer which is two or more) application priorities specified from the external and N physical priorities to be used at actual transmission to the transmission line where 1 signifies the highest priority and N signifies the lowest priority, setting N priority time slots after a packet comes to an end on the transmission line where the time slots are taken as PTS1, PTS2, . . . , PTSN in latening time sequence so that a packet having a physical priority=m (1≦m≦N) has a transmission right on and after a time slot PTSm, making one or more slave communication apparatus receive conversion information sent from a master communication apparatus to produce a conversion table for determining a physical priority of a transmission packet in accordance with the conversion table, and, when the application priority of the packet to be transmitted from itself is absent in the conversion table, transmitting the packet using a physical priority having a value equal to that of the application priority. This provides an excellent communication method capable of effectively utilizing the transmission line while enabling the communication according to packet priority.

### BRIEF DESCRIPTION OF THE DRAWINGS

Other objects and features of the present invention will become more readily apparent from the following detailed description of the preferred embodiments taken in conjunction with the accompanying drawings in which:

FIG. 1 is an illustration useful for explaining a communication method according to a first embodiment of the present invention;

FIG. 2 is a block diagram showing a communication apparatus according to a second embodiment of the present invention;

FIG. 3 is an illustration of a configuration of a network according to the present invention;

FIG. 4 is an illustration of a configuration of a packet to be used in a fifth embodiment of the present invention;

FIG. 5 is a block diagram showing a communication apparatus according to the fifth embodiment of the present invention;

FIG. 6 is an illustration of a configuration of a packet to be used in a seventh embodiment of the present invention;

FIG. 7 is a block diagram showing a communication apparatus according to the seventh embodiment of the present invention;

FIG. 8 is an illustration useful for explaining a communication method according to an eighth embodiment of the present invention;

FIG. 9 is a block diagram showing a communication apparatus according to a ninth embodiment of the present invention;

FIG. 10 is a block diagram showing a communication apparatus according to an eleventh embodiment of the present invention;

FIG. 11 is an illustration useful for explaining a collision processing time slot according to the present invention;

FIG. 12 is a block diagram showing a communication apparatus according to a thirteenth embodiment of the present invention;

FIG. 13 is a block diagram showing a communication apparatus according to a fifteenth embodiment of the present invention;

FIG. 14 is a block diagram showing a communication apparatus according to a seventeenth embodiment of the present invention;

FIG. 15 is a block diagram showing a communication apparatus according to a nineteenth embodiment of the present invention;

FIG. 16 is a block diagram showing a communication apparatus according to a twenty-first embodiment of the present invention;

FIG. 17 is an illustration useful for explaining a special time slot according to the present invention;

FIG. 18 is a block diagram showing a communication apparatus according to a twenty-fifth embodiment of the present invention;

FIG. 19 is a block diagram showing a communication apparatus according to a twenty-seventh embodiment of the present invention;

FIG. 20 is a block diagram showing a communication apparatus according to a thirty-second embodiment of the present invention;

FIG. 21 is a block diagram showing a communication apparatus according to a thirty-fourth embodiment of the present invention;

FIG. 22 is a block diagram showing a communication apparatus according to a thirty-eighth embodiment of the present invention;

FIG. 23 is a block diagram showing a communication apparatus according to a thirty-ninth embodiment of the present invention;

FIG. 24 is a block diagram showing a communication apparatus according to a fortieth embodiment of the present invention;

FIG. 25 is a block diagram showing a communication apparatus according to a forty-fifth embodiment of the present invention;

FIG. 26 is a block diagram showing a communication apparatus according to a forty-sixth embodiment of the present invention;

FIG. 27 is a block diagram showing a communication apparatus according to a forty-seventh embodiment of the present invention;

FIG. 28 is a block diagram showing a communication apparatus according to a forty-eighth embodiment of the present invention;

FIG. 29 is an illustration of a configuration of a network showing the relationship between a conventional communication apparatus and a transmission line; and

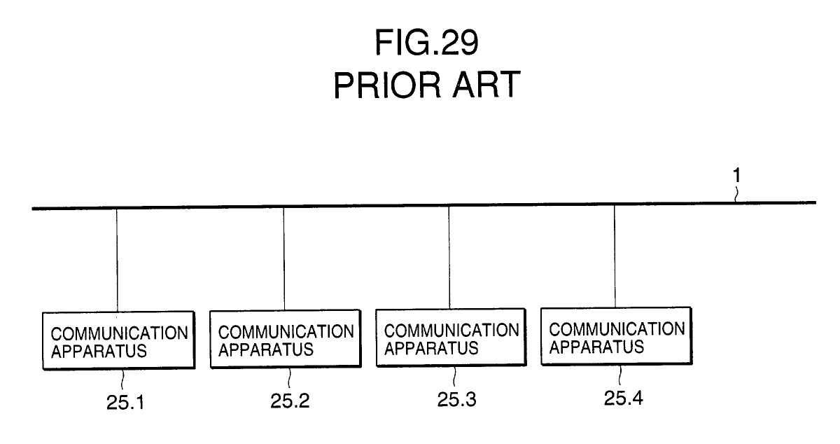

FIG. 30 is an illustration for explaining a priority time slot according to a conventional method.

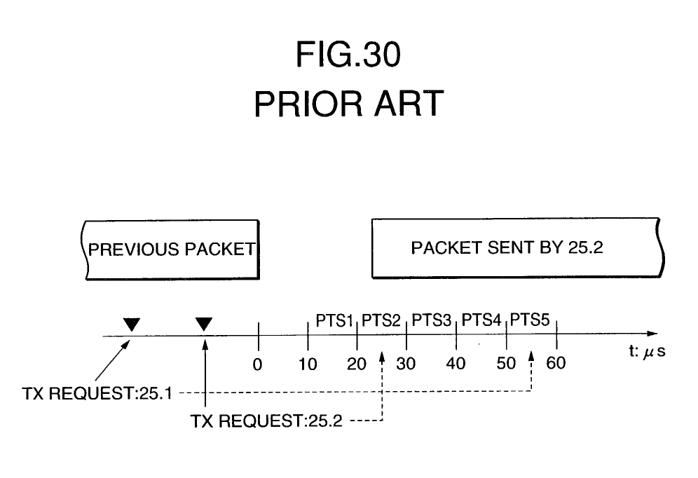

### DESCRIPTION OF THE PREFERRED EMBODIMENTS

Embodiments of the present invention will be described hereinbelow with reference to the drawings.

In a feature of the present invention, the priority of a packet flowing on a transmission line is observed for a given period of time, and when a high-priority packet is absent thereon for the given period time, a low-priority packet is transmitted to an earlier time slot PTS.

Two new concepts on priority (precedence) are introduced in this arrangement.

(1) Application Priority (which will hereinafter be referred to simply as an “APP”): priority determined according to character or kind of information; for example, a high priority is set for image or voice while a low priority is set for computer data. In each of embodiments, this priority is determined in the exterior of communication apparatus.

(2) Physical Priority (which will hereinafter be referred to simply as a “PHP”): priority representative of time slot PTS from which transmission is made. The value thereof becomes an actual priority at packet transmission.

As will be described in each of the embodiments of the present invention, in a communication method of transmitting packets according to carrier sense multiple access system with a collision detection function between plural communication apparatus each connected to a transmission line which can logically be considered to be of a bus type, for example, each of APP and PHP takes five steps from 1 to 5, where 1 represents the highest priority. Naturally, the present invention is not limited to the five priorities.

(First Embodiment)

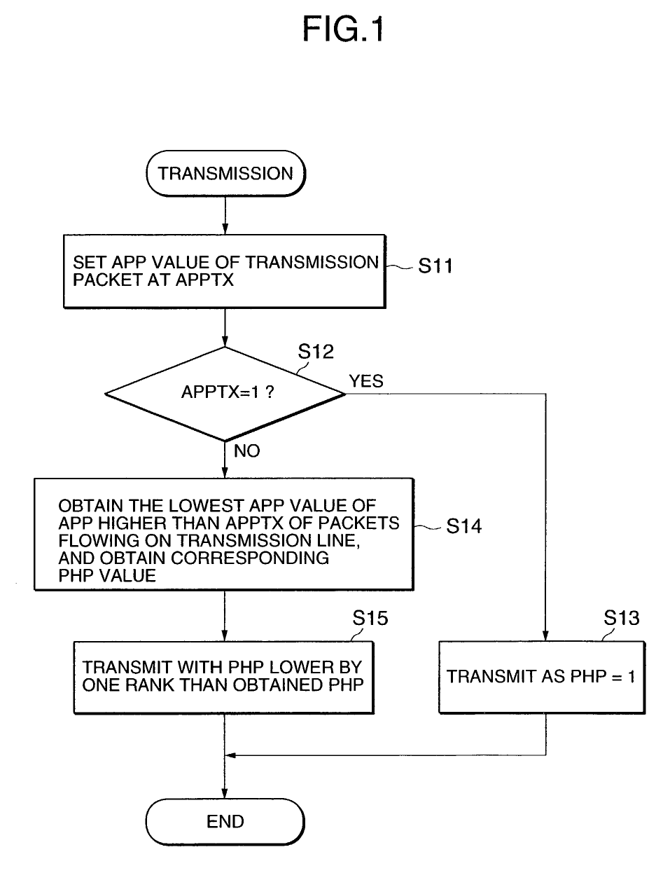

A description will be given hereinbelow of a communication method according to a first embodiment of the present invention. A communication apparatus employing a communication method according to the invention carries out an observation of a packet existing on a transmission line at intervals of a given period of time to seize a PHP of a packet having one APP which is on the transmission. The contents thereof are updated at intervals of given period of time. This communication apparatus makes the transmission of a packet according to a method shown in FIG. 1.

That is, as FIG. 1 shows, an APP value of a packet (transmission packet) to be transmitted now is inputted. In this case, the value is taken as APPTX (step S11). When the APPTX assumes 1, since this is the highest priority, PHP=1 is allocated thereto without condition (steps S12 and S13). If the APPTX does not assume 1, the previous observation information is referred to. A PHP lower by one rank than a PHP used by a packet having the lowest APP of APPs higher than APPTX is allocated thereto (steps S12, S14 and S15). For example, if the APPTX is 3 and the observation information is as shown in the table 1, of the APPs higher than the APPTX, the APPs which are put to use are APP=1 and APP=2, and of these APPs, the lowest APP is APP=2. From the table 1, a packet having APP=2 is transmitted as (through the use of) PHP=2 and, therefore, a packet having APP=3, to be transmitted from this apparatus, is transmitted as the PHP=3 lower by one rank than the PHP=2.

TABLE 1

| APP | PHP |
|---|---|
| 1 | 1 |
| 2 | 2 |
| 5 | 3 |

In this connection, although a packet having APP=5 is transmitted as PHP=3, when this apparatus transmits an APP=3 packet through the use of PHP=3, the observation information in each of communication apparatus is updated, and a communication apparatus, which tries to transmit a packet having APP=5, lowers the priority thereof, thus transmitting it as PHP=4.

In addition, if no packet exists on the transmission line for a given period of time (until the elapse of a given period of time), the observation information disappears, so a packet having any APP value can be transmitted as PHP=1.

That is, according to this embodiment, in a communication method of transmitting packets according to a carrier sense multiple access system with a collision detection function, N (N represents an integer which is two or more) application priorities are set by being specified from the external and N physical priorities to be taken at actual transmission to the transmission line are set, where 1 signifies the highest priority and N signifies the lowest priority. Moreover, N priority time slots are set after a packet comes to an end on the transmission line where the time slots are taken as PTS1, PTS2, . . . , PTSN in latening time sequence so that a packet having physical priority=m (1≦m≦N) has a transmission right on and after a time slot PTSm. Still moreover, an observation of the application priority and physical priority of a packet flowing on the transmission line is carried out for a given period of time for seizing the correspondence between the application priority and the physical priority, and a physical priority lower by one rank than a physical priority of a packet having an application priority higher than an application priority of the packet to be transmitted from one apparatus is set as a physical priority of a packet to be transmitted from the one apparatus. On the other hand, if a packet having an application priority higher than the application priority of the packet to be transmitted from the one apparatus does not exist on the transmission line, the physical priority set at 1. The conversion rule for the physical priority and the application priority is updated at intervals of the given time period of the priority observation. This eliminates the need for waiting unnecessarily for transmission start until a late time slot PTS is reached, thereby effectively utilizing the transmission line.

(Second Embodiment)

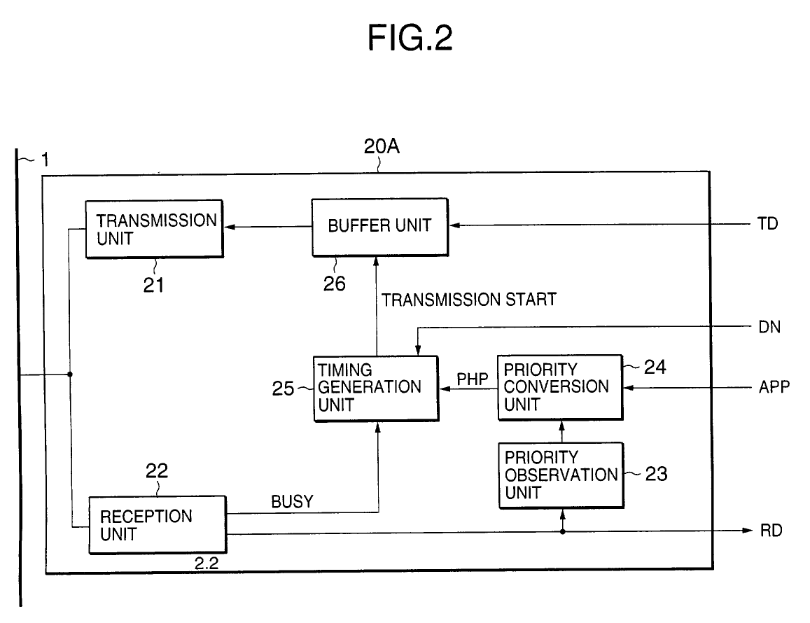

The second embodiment of the present invention relates to a communication apparatus for realizing the communication method according to the first embodiment. FIG. 2 is an illustration of an example of a configuration of communication apparatus according to the second embodiment of the invention.

As FIG. 2 shows, a communication apparatus 20A is connected to a transmission line 1. As components of this communication apparatus 20A, there are used a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive the signal existing on the transmission line for conversion into a digital signal, a priority observation unit 23 for observing, on the basis of the digital signal outputted from the reception unit 22, the correspondence between a physical priority and application priority of a packet flowing on the transmission line 1, a priority conversion unit 24 for accumulating the results of observations by the priority observation unit 23 at intervals of given period of time to produce and update a conversion table between a physical priority and an application priority for obtaining a corresponding physical priority on the basis of a packet application priority inputted together with transmission packet data from the external and outputting it to a timing generation unit 25, and a buffer unit 26 having a function to temporarily retain transmission packet data.

Secondly, a description will be given hereinbelow of a case in which a packet transmission request occurs while a packet issued from another communication apparatus exists on the transmission line 1.

The priority observation unit 23 always carries out observation of packets flowing on the transmission line 1 and extracts the APP values and PHP values therefrom to output them to the priority conversion unit 24. The priority conversion unit 24 accumulates the information thereon to produce a table for conversion between APPs and PHPs. The table 1 is one example of the conversion table. The conversion table has a two-plane configuration. While one plane is put to use, in the other plane, the information from the priority observation unit 23 are accumulated. These planes are switched from one to another at intervals of given period of time (for example, one minute), thereby updating the conversion table.

When a transmission request occurs, packet data TD to be transmitted is once stored in the buffer unit 26. In addition, a completion signal DN representative of the completion of writing of data is inputted to the timing generation unit 25. Simultaneously, the priority conversion unit 24 receives an APP value to obtain a PHP value corresponding thereto on the basis of the conversion table for notifying it to the timing generation unit 25. The timing generation unit 25 starts up a timer at a moment of a busy signal being non-active, and waits for a period of time corresponding to the given PHP value and then outputs a transmission start signal to the buffer unit 26. Upon receipt of this transmission start signal, the buffer unit 26 outputs packet data to the transmission unit 21. This operation enables a packet to be transmitted from a time slot PTS corresponding to a physical priority PHP.

If a packet is transmitted from another communication apparatus before the timing of this PTS although the busy signal becomes non-active, the busy signal becomes active and, hence, the timer is stopped and is reset and waits until the busy signal again becomes non-active.

(Third Embodiment)

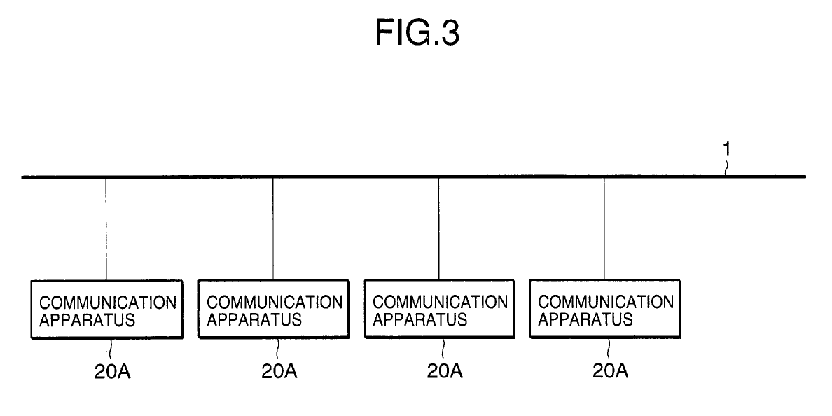

A plurality of communication apparatus each equal to the above-described communication apparatus are connected to a transmission line 1 which can logically be considered to be of a bus type as shown in FIG. 3. This configuration enables the construction of a communication system which can reduce the lowering of the transmission efficiency irrespective of the setting of priorities.

(Fourth Embodiment)

The fourth embodiment of the present invention relates to, in the communication method according to the first embodiment, a communication method of learning a PHP value of a packet flowing on the transmission line 1. According to this method, a communication apparatus carries out observation of packets on the transmission line 1 to measure the elapsed time from when one packet comes to an end until the next packet starts, and obtains a time slot, from which the packet enters into transmission, on the basis of the measurement result, thereby learning the PHP value of the packet. This communication method provides an advantage of reducing the information to be added to the original packet for learning a PHP.

(Fifth Embodiment)

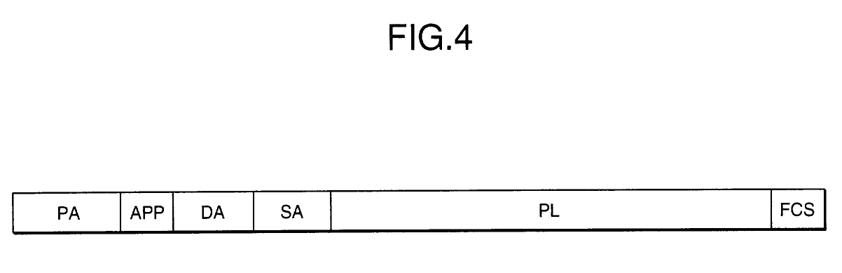

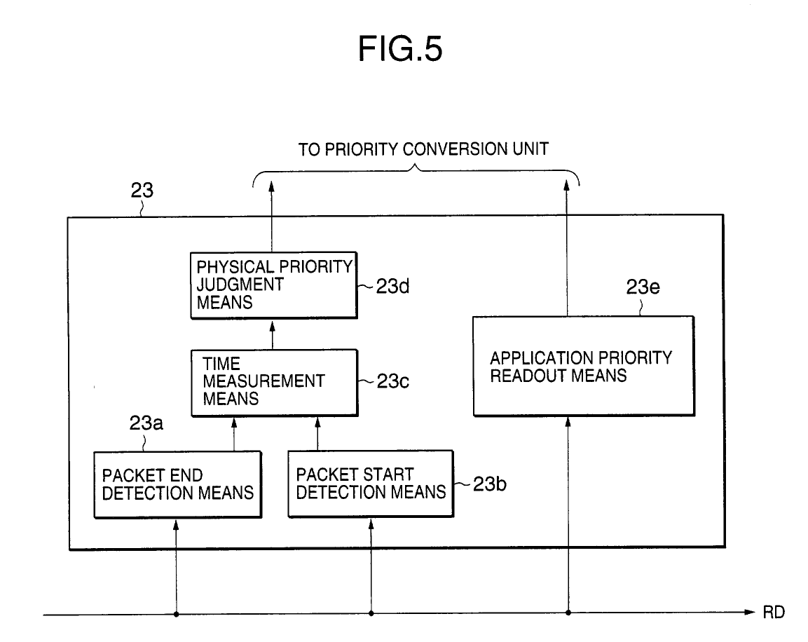

The fifth embodiment of the present invention relates to a communication apparatus for realizing the above-described communication method according to the fourth embodiment. A configuration of a packet to be used in the present invention includes an area indicative of an APP value as shown in FIG. 4. In the illustration, PA represents a preamble, DA denotes a destination address, SA depicts a source address, PL signifies a payload, and FCS designates a frame check sequence. In the communication apparatus according to the fifth embodiment, the priority observation unit 23 (see FIG. 2) is made to have an internal configuration shown in FIG. 5.

As FIG. 5 shows, the priority observation unit 23 is composed of a packet end detection means 23a having a function to detect that a packet comes to an end, a packet start detection means 23b having a function to detect that the next packet starts, a time measurement means 23c for obtaining a time interval between one packet and the next packet, a physical priority judgment means 23d having a function to obtain a physical priority value on the basis of the time interval from the time measurement means 23c for outputting it to the priority conversion unit 24, and an application priority readout means 23e having a function to output, to the priority conversion unit 24, an application priority read out from a received packet RD.

In this configuration, the packet end detection means 23a issues a signal to the time measurement means 23c at the timing of the detection of end of a packet. The packet start detection means 23b issues a signal to the time measurement means 23c at the timing of the detection of start of the next packet. On the basis of these signals, the time measurement means 23c obtains a length of time from the end of the former packet to the start of the next packet, and notifies it to the physical priority judgment means 23d. Since it is possible to learn, on the basis of the time length, a time slot PTS at which the transmission of the packet starts, the physical priority judgment means 23d can obtain (judge) the PHP value on the basis of that time slot PTS. If this time length is longer than a length of time taken until the time slot PTS5 is reached, the physical priority judgment means 23d does not make the judgment. Meanwhile, the application priority readout means 23e reads out an APP value from an APP value area of the packet.

(Sixth Embodiment)

The sixth embodiment of the present invention relates to, in the communication method according to the first embodiment, a communication method of learning a PHP value of a packet flowing on the transmission line 1. In this embodiment, an area indicative of a PHP value and an area indicative of an APP value are provided in a packet. According to this communication method, a communication apparatus can learn a PHP value and an APP value by reading out these values from a packet. The communication method according to this embodiment permits learning a PHP value and an APP value of each of all packets, thus enabling fast and precise creation of a priority conversion table.

(Seventh Embodiment)

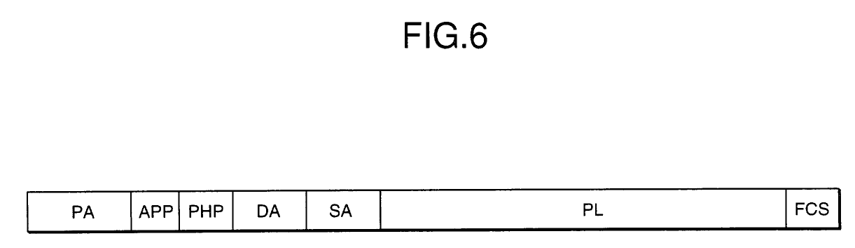

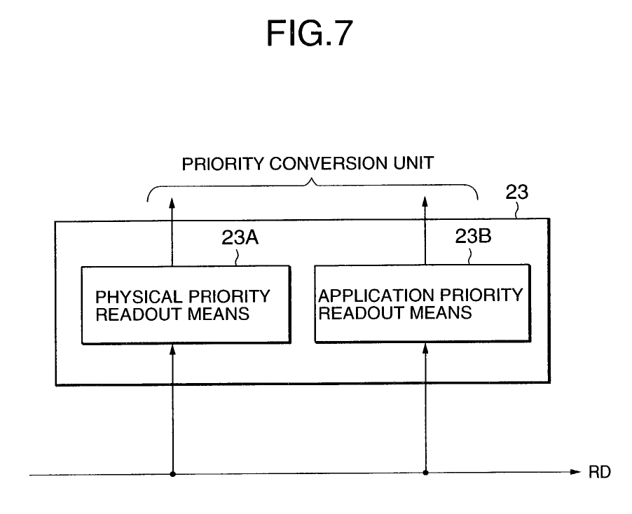

The seventh embodiment of the present invention relates to a communication apparatus for realizing the above-described communication method according to the sixth embodiment. In this embodiment, a configuration of a packet to be used includes an area indicative of an APP value and an area indicative of a PHP value as shown in FIG. 6. In the communication apparatus according to the seventh embodiment, the priority observation unit 23 (see FIG. 2) is made to have an internal configuration shown in FIG. 7.

As FIG. 7 shows, the priority observation unit 23 is composed of a physical priority readout means 23A having a function to read out a physical priority from a received packet for outputting it to the priority conversion unit 24 and an application priority readout means 23B having a function to read out an application priority from the received packet for outputting it to the priority conversion unit 24.

In this configuration, the physical priority readout means 23A reads out a PHP value from the PHP value area of a received frame, while the application priority readout means 23B reads out an APP value from the APP value area of the packet. This enables effective notification of these values to the priority conversion unit 24.

(Eighth Embodiment)

For example, in a case in which a conversion table for observation information is as shown in the table 1, when a packet having APP=4 is transmitted in a state where packets having APP=5 flow in large quantities, the physical priorities of both the packets turn to PHP=3, which causes a possibility of the occurrence of collision on the transmission line 1. The packet having APP=4 is originally to be transmitted preferentially with respect to the packet having APP=5, but, after the occurrence of collision, there is a possibility of the packet having APP=5 being transmitted prior to the packet having APP=4. Not until the packet having APP=4 is transmitted, the conversion table in each communication apparatus is rewritten, so difficulty is experienced in securing the precedence of the packet having APP=4.

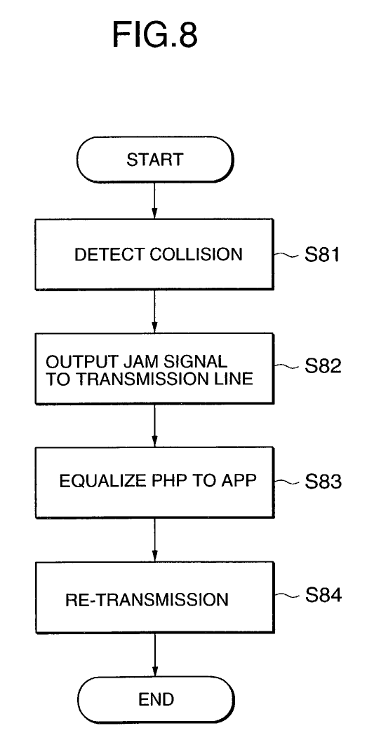

The eighth embodiment is for solving this problem. FIG. 8 shows a procedure in the communication method according to the eighth embodiment of the present invention.

As FIG. 8 shows, according to this communication method, when detecting a collision, a communication apparatus outputs a jam signal to the transmission line 1 for a given period of time (steps S81 and S82). Following this, the communication apparatus carries out re-transmission in a state where the PHP value is equalized to the APP value irrespective of the contents of the conversion table (steps S83 and S84). At this time, each time slot PTS is set with the jam signal being considered as a previous packet signal.

According to this communication method, in the above-mentioned example, since the packet having APP=5 holds PHP=5 and the packet having APP=4 holds PHP=4, no collision occurs at re-transmission, and the packet having APP=4 is transmitted preferentially.

(Ninth Embodiment)

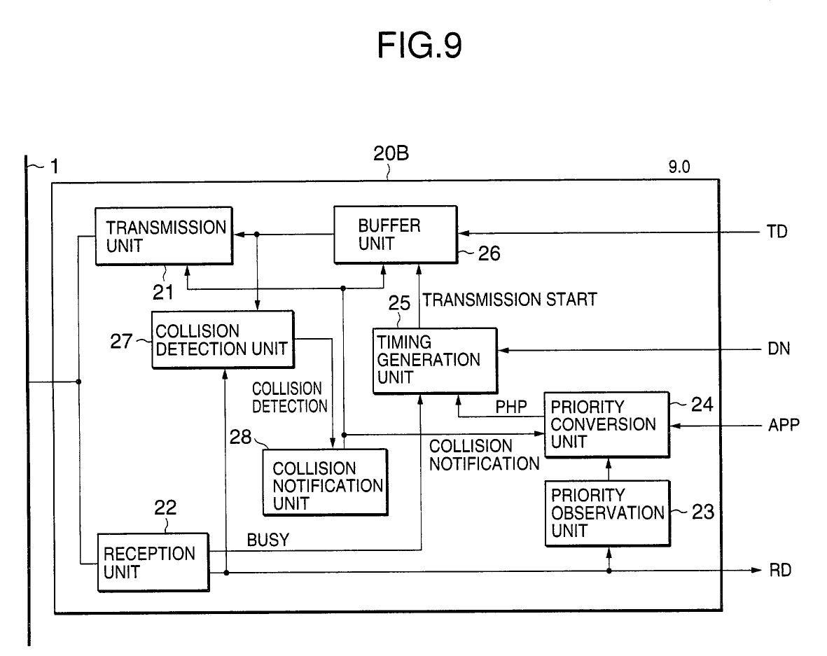

The ninth embodiment of the present invention relates to a communication apparatus for realizing the above-described communication method according to the eighth embodiment. FIG. 9 shows an example of a configuration of a communication apparatus 20B according to the ninth embodiment. The same parts as those in the communication apparatus 20A according to the second embodiment shown in FIG. 2 are marked with the same reference numerals.

As components, this communication apparatus 20B comprises, as in the case of the second embodiment, a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing, on the basis of the digital signal outputted from the reception unit 22, the correspondence between a physical priority and application priority of a packet flowing on the transmission line 1, a priority conversion unit 24 for accumulating the results of observations by the priority observation unit 23 at intervals of given period of time to produce and update a conversion table between a physical priority and an application priority for obtaining a corresponding physical priority on the basis of a packet application priority inputted together with transmission packet data from the external and outputting it to a timing generation unit 25, and a buffer unit 26 having a function to temporarily retain transmission packet data, and as further components, comprises a collision detection unit 27 having a function to compare an input signal to the transmission unit 21 and an output signal from the reception unit 22 for, if they do not agree with each other, making a decision to the occurrence of a collision on the transmission line 1 and outputting a collision detection signal, and a collision notification unit 28 having a function to output a collision notification signal which is active for a given period of time after the collision detection.

The ordinary transmission operation is the same as that of the second embodiment. However, the buffer unit 26 is made to maintain a copy of packet information even if it receives a transmission start signal and outputs the packet information to the transmission unit 21.

A description will be given hereinbelow of only an operation to be conducted in a case in which a collision occurs.

When a collision occurs on the transmission line 1, the collision detection unit 27 outputs a collision detection signal to the collision notification unit 28, The collision notification unit 28 issues a collision notification signal for a given period of time (for example, 4 μs). The transmission unit 21 sends out a jam signal to the transmission line 1 while that signal is active, and the priority conversion unit 24 equalizes the PHP value to the APP value irrespective of the contents of the conversion table and notifies the PHP to the timing generation unit 25. The timing generation unit 25 measures a timing of a proper time slot PTS at the timing that the collision notification signal becomes non-active. Moreover, if the collision notification signal does not become active when a maximum time length (for example, 5 μs) from the start of transmission of packet information to the collision detection elapses, the buffer unit 26 considers that the packet has normally been transmitted and, hence, erases the copy of the packet information. This can realize the communication method according to the eighth embodiment.

(Tenth Embodiment)

The tenth embodiment of the present invention relates to a communication method for solving the problem mentioned in the eighth embodiment.

Let it be assumed that the conversion table is as shown in the table 1, and when a communication apparatus transmits an APP=5 packet as PHP=3, a new communication apparatus B transmits a packet having APP=4. In this case, the packet having APP=4, which does not exist in the conversion table, is transmitted as PHP=3 according to the rule. At this time, if both the packets collide against each other, in the above-described communication method according to the eighth embodiment, they are re-transmitted as PHP=4 and 5. However, in fact, the slot time PTS3 has not been put to use. Therefore, if the packet having APP=4 is re-transmitted as PHP=3, the waiting time becomes shorter.

In this communication method, in the case of the occurrence of collision, for the re-transmission, the communication apparatus A selects a PHP value randomly in a range of 4 and 5, while the communication apparatus B selects it randomly in a range of 3 and 4. There are four PHP combinations when the communication apparatus A and B select the PHPs, and of these, in the case of two combinations, the communication apparatus B can carry out the transmission as PHP=3. Moreover, with one combination, the communication apparatus B can carry out the transmission as PHP=4. That is, the communication apparatus B can carry out the transmission at a probability of ¾, and re-collision occurs at a probability of ¼.

In addition, in a case in which both the communication apparatus A and B assume APP=4, since both select the PHP value randomly in a range of 3 and 4, the probability of the re-collision lowers at the re-transmission.

The communication method according to the tenth embodiment is effective in the case of using a PHP value higher than an APP value through the conversion, otherwise it is made to conduct the same operation as the communication method according to the eighth embodiment.

(Eleventh Embodiment)

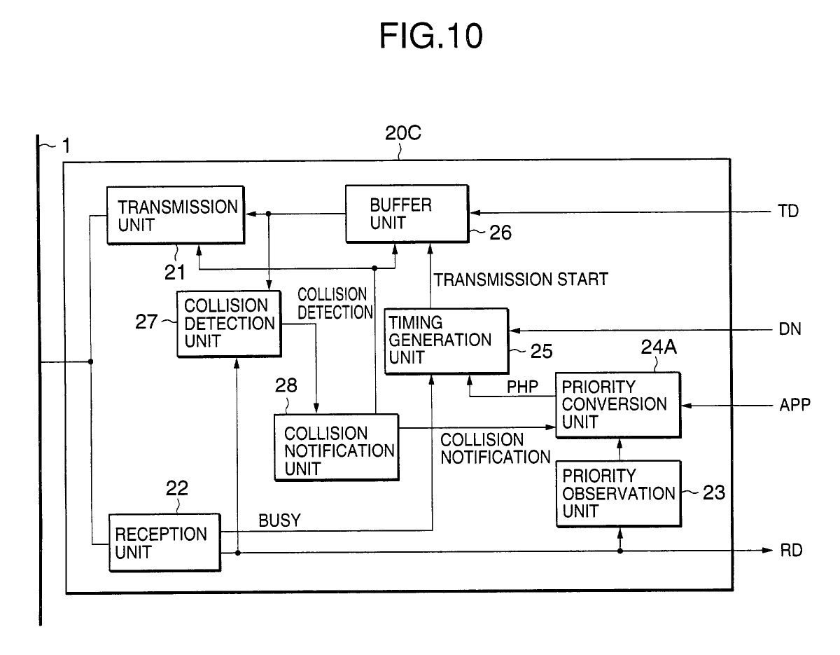

The eleventh embodiment of the present invention relates to a communication apparatus for realizing the above-described communication method according to the tenth embodiment. The basic configuration thereof is similar to that of the ninth embodiment shown in FIG. 9. FIG. 10 is an illustration of an example of a configuration of a communication apparatus 20C according to the eleventh embodiment. In FIG. 10, the same parts as those of the communication apparatus 20B according to the ninth embodiment shown in FIG. 9 are marked with the same reference numerals.

In FIG. 10, the communication apparatus 20C comprises, as well as the ninth embodiment, a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing, on the basis of the digital signal outputted from the reception unit 22, the correspondence between a physical priority and application priority of a packet flowing on the transmission line 1, a priority conversion unit 24A for accumulating the results of observations by the priority observation unit 23 at intervals of given period of time to produce and update a conversion table between a physical priority and an application priority for obtaining a corresponding physical priority on the basis of a packet application priority inputted together with transmission packet data from the external and outputting it to a timing generation unit 25, a buffer unit 26 having a function to temporarily retain transmission packet data, a collision detection unit 27 having a function to compare an input signal to the transmission unit 21 and an output signal from the reception unit 22 for, if they do not agree with each other, making a decision to the occurrence of a collision on the transmission line 1 and outputting a collision detection signal, and a collision notification unit 28 having a function to output a collision notification signal which is active for a given period of time after the collision detection.

A basic operation of this communication apparatus is also similar to that of the ninth embodiment except for an operation of the priority conversion unit 24A.

Upon receipt of a collision notification signal, the priority conversion unit 24A sets the PHP value of that packet randomly to one of a value equal to the APP value and a value higher by one than the APP value, and notifies it to the timing generation unit 25. In this case, if a conversion into the PHP value higher than the APP value is absent in the conversion table, the priority conversion unit 24A does not conduct this operation, and notifies APP=PHP to the timing generation unit 25. This can realize the communication method according to the tenth embodiment.

(Twelfth Embodiment)

The above-described eighth to eleventh embodiments are effectively employed in a case in which packets having different APPs collide against each other. On the other hand, the twelfth to twenty-third embodiments provide methods/apparatus which are also effective in the case of the collision between packets equal in APP to each other.

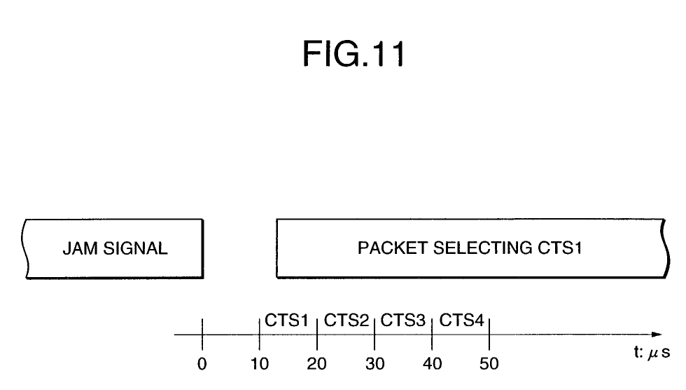

In the twelfth embodiment, after a transmission of a jam signal takes place due to the occurrence of a collision, collision processing time slots (CTSs) are set as shown in FIG. 11. The CTSs are two or more in number, and a description will be given hereinbelow in the case of four CTSs.

A communication apparatus, which has started transmission and has caused a collision, randomly selects one of the time slots CTS1 to CTS4 and starts the re-transmission at the one time slot CTS. Accordingly, a communication apparatus, which has selected an earlier time slot CTS, can carry out the re-transmission. On the other hand, if two or more communication apparatus have selected the same time slot CTS, re-collision will occur. This processing can suppress the probability of re-collision after the occurrence of a collision and can achieve smooth re-transmission processing.

In addition, in the case of realizing a communication apparatus using this method, if the width of the time slot CTS is set to be equal to the width of the time slot PTS, the timing processing overlaps largely with that for the time slot PTS, which provides an advantage of simplifying the hardware or software.

(Thirteenth Embodiment)

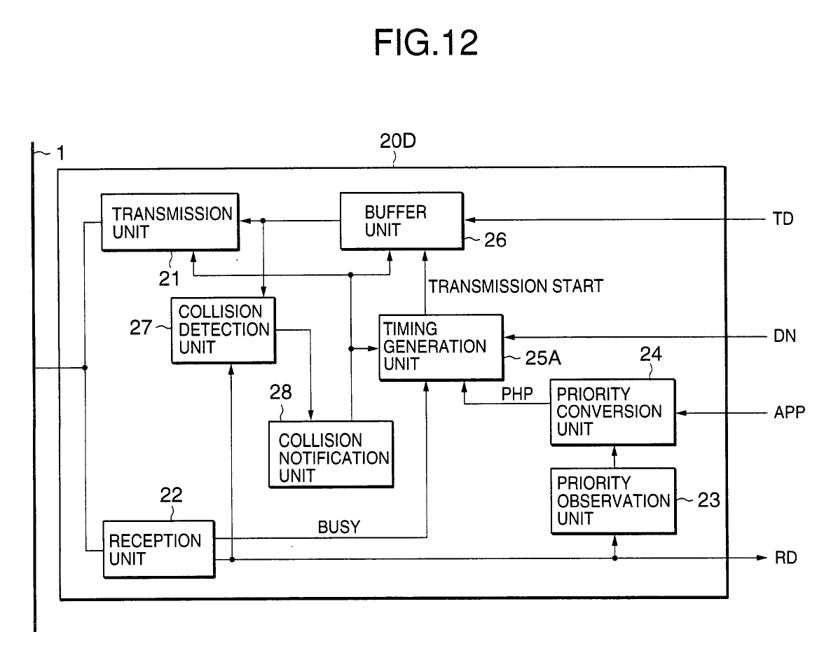

The thirteenth embodiment of the present invention relates to a communication apparatus for realizing the above-described communication method according to the twelfth embodiment. FIG. 12 shows an example of a configuration of a communication apparatus 20D according to the thirteenth embodiment.

As FIG. 12 shows, the communication apparatus 20D according to the thirteenth embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing, on the basis of the digital signal outputted from the reception unit 22, the correspondence between a physical priority and application priority of a packet flowing on the transmission line 1, a priority conversion unit 24 for accumulating the results of observations by the priority observation unit 23 at intervals of given period of time to produce and update a conversion table between a physical priority and an application priority for obtaining a corresponding physical priority on the basis of a packet application priority inputted together with transmission packet data from the external and outputting it to a timing generation unit 25A, a buffer unit 26 having a function to temporarily retain transmission packet data, a collision detection unit 27 having a function to compare an input signal to the transmission unit 21 and an output signal from the reception unit 22 for, if they do not agree with each other, making a decision to the occurrence of a collision on the transmission line 1 and outputting a collision detection signal, and a collision notification unit 28 having a function to output a collision notification signal which is active for a given period of time after the collision detection.

In the above-described configuration, even if receiving a transmission start signal and outputting packet information to the transmission unit 21, the buffer unit 26 is made to maintain a copy of the packet information. If a collision occurs on the transmission line 1, the collision detection unit 27 outputs a collision detection signal to the collision notification unit 28. The collision notification unit 28 issues a collision notification signal for a given period of time (for example, 4 μs). The transmission unit 21 sends out a jam signal to the transmission line 1 while that signal is active. The timing generation unit 25A selects a time slot CTS randomly and measures a proper CTS timing at the timing that the collision notification signal becomes non-active, When that timing is reached, the timing generation unit 25 outputs a transmission start signal to the buffer unit 26.

Moreover, if the collision notification signal does not become active when a maximum time length (for example, 5 μs) from the start of transmission of packet information to the collision detection elapses, the buffer unit 26 considers that the packet has normally been transmitted and, hence, erases the copy of the packet information. This can realize the communication method according to the twelfth embodiment.

(Fourteenth Embodiment)

The fourteenth embodiment of the present invention is for the purpose of reducing the probability of re-collision. In this fourteenth embodiment, as in the case of the above-described twelfth embodiment, a communication apparatus, which has started transmission and has caused a collision, selects one of time slots CTS1 to CTS4 randomly, and starts the re-transmission at that CTS. Accordingly, a communication apparatus, which has selected an earlier CTS, can carry out the re-transmission. On the other hand, if two or more communication apparatus have selected the same CTS, re-collision will occur. In a case in which a re-collision occurs, then the number of CTSs is increased up to five.

According to the twelfth embodiment, after the first collision, the probability that the re-collision continuously occurs twice is (4/16)×(4/16)=1/16. On the other hand, with this communication method according to the fourteenth embodiment, the probability is considerably decreased to (4/16)×(5/25)=1/20.

Incidentally, if the re-collision further occurs, it is also appropriate that the number of CTSs is increased or that the number thereof is maintained intactly (five).

(Fifteenth Embodiment)

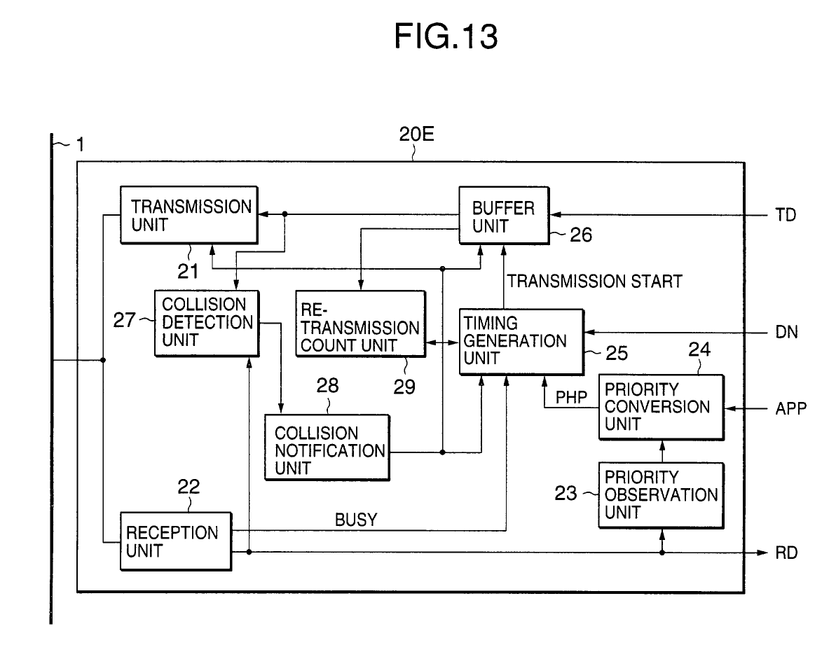

The fifteenth embodiment of the present invention relates to a communication apparatus for realizing the above-described communication method according to the fourteenth embodiment. FIG. 13 is an illustration of an example of a configuration of a communication apparatus 20E according to the fifteenth embodiment.

In FIG. 13, the communication apparatus 20E according to the fifteenth embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing, on the basis of the digital signal outputted from the reception unit 22, the correspondence between a physical priority and application priority of a packet flowing on the transmission line 1, a priority conversion unit 24 for accumulating the results of observations by the priority observation unit 23 at intervals of given period of time to produce and update a conversion table between a physical priority and an application priority for obtaining a corresponding physical priority on the basis of a packet application priority inputted together with transmission packet data from the external and outputting it to a timing generation unit 25, a buffer unit 26 having a function to temporarily retain transmission packet data, a collision detection unit 27 having a function to compare an input signal to the transmission unit 21 and an output signal from the reception unit 22 for, if they do not agree with each other, making a decision to the occurrence of a collision on the transmission line 1 and outputting a collision detection signal, a collision notification unit 28 having a function to output a collision notification signal which is active for a given period of time after the collision detection, and a re-transmission count unit 29 having a function to increment a count value whenever receiving a re-transmission notification from the timing generation unit 25 and to reset the count value when receiving a notification representative of the completion of the normal transmission from the buffer unit 26.

The operation at the normal condition is similar to those of the above-described embodiment, and the description thereof will be omitted for brevity. Therefore, a description will be made hereinbelow of an operation to be conducted in a case in which a collision occurs even in the re-transmission after a collision. Let it be assumed that the initial value of the re-transmission count unit 29 is zero.

After the first collision, each part conducts an operation, including outputting a jam signal, as well as the thirteenth embodiment. In addition, prior to the re-transmission, the timing generation unit 25 sees the value of the re-transmission count unit 29. At this time, the value is zero, and it does not conduct special operations. Simultaneously with conducting the re-transmission processing, it sends an increment pulse to the re-transmission count unit 29. In response to the increment pulse, the re-transmission count unit 29 increments its own value by one.

In a case in which a collision occurs even at the re-transmission, although each part conducts an operation similar to that for the first collision, the timing generation unit 25 sees the value of the re-transmission count unit 29 and, since the value thereof is not zero (is one), increases the number of the time slots CTSs to five, with one time slot CTS being selected therefrom.

Moreover, if the collision notification signal does not become active when a maximum time length (for example, 5 μs or more) from the start of transmission of packet information to the collision detection elapses, the buffer unit 26 considers that the packet has normally been transmitted and, hence, erases the copy of the packet information, and further sends out a reset signal to the re-transmission count unit 29 for setting the count value at zero.

Incidentally, in a case in which the number of the time slots CTSs is increased whenever a collision occurs, when the timing generation unit 25 sees the value of the re-transmission count unit 29, the number of time slots CTSs is set at the value of the re-transmission count unit 29+4.

(Sixteenth Embodiment)

In the above-described communication method according to the fourteenth embodiment, a time clot CTS is selected randomly for the re-transmission after the collision. On the other hand, in a communication method according to the sixteenth embodiment, an APP value of a packet to be transmitted is referred to at the selection of a time slot CTS. If the APP value thereof is 4 or 5, one of the time slots CTS3 and CTS4 is randomly selected while, if the APP value is in a range of 1 to 3, one of the time slots CTS1 and CTS2 is randomly selected.

That is, in place of the random selection of the collision processing time slot, in the case of the transmission of a packet having an application priority higher than N/2, a collision processing time slot having a number larger than X/2 is selected, wherein X is the number of the time slots CTSs, and in the case of the transmission of a packet having an application priority equal to or below N/2, a collision processing time slot having a number equal to or below X/2 is selected.

This can suppress the occurrence of re-collision in a case in which a low APP packet collides against a high APP packet because the priority of the low APP packet is converted into a high PHP according to a conversion table.

(Seventeenth Embodiment)

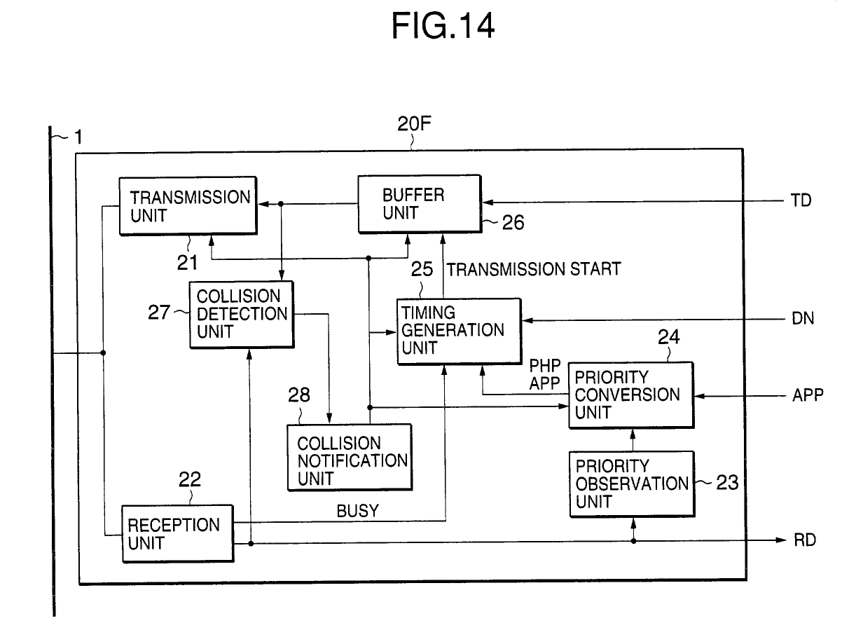

The seventeenth embodiment of the present invention relates to a communication apparatus for realizing the above-described communication method according to the sixteenth embodiment. FIG. 14 shows an example of a configuration of a communication apparatus 20F according to the seventeenth embodiment.

As FIG. 14 shows, the communication apparatus 20F according to the seventeenth embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing, on the basis of the digital signal outputted from the reception unit 22, the correspondence between a physical priority and application priority of a packet flowing on the transmission line 1, a priority conversion unit 24 for accumulating the results of observations by the priority observation unit 23 at intervals of given period of time to produce and update a conversion table between a physical priority and an application priority for obtaining a corresponding physical priority on the basis of a packet application priority inputted together with transmission packet data from the external and outputting it to a timing generation unit 25, a buffer unit 26 having a function to temporarily retain transmission packet data, a collision detection unit 27 having a function to compare an input signal to the transmission unit 21 and an output signal from the reception unit 22 for, if they do not agree with each other, making a decision to the occurrence of a collision on the transmission line 1 and outputting a collision detection signal, and a collision notification unit 28 having a function to output a collision notification signal which is active for a given period of time after the collision detection.

The ordinary operation is the same as that of the communication apparatus according to the thirteenth embodiment, and the description thereof will be omitted for simplicity. A description will be given hereinbelow of a case in which the transmission of a packet having APP=2 starts newly as PHP=2 in a state where a packet having APP=5 is flowing after the conversion into PHP=2 according to a conversion table, and a collision occurs.

When a collision notification signal is inputted to the priority conversion unit 24, the priority conversion unit 24 notifies an APP value of a packet for transmission to the timing generation unit 25. On the basis of this value, the timing generation unit 25 randomly selects one of the time slots CTS3 and CTS4 when the APP value is 4 or 5 and randomly selects one of the time slots CTS1 and CTS2 when the APP value is in a range of 1 to 3.

That is, after a collision notification signal becomes non-active, in place of randomly selecting one of X collision processing time slots, the timing generation unit 25 selects a collision processing time slot having a number larger than X/2 when the application priority of a re-transmission packet is larger than N/2, and selects a collision processing time slot having a number equal to or below X/2 when the application priority of the re-transmission packet is equal to or below N/2. This can realize the communication method according to the sixteenth embodiment.

(Eighteenth Embodiment)

The above-described communication method according to the sixteenth embodiment is made to classify APPs into two stages for distributing the first and second halves of time slots CTS, and is easily realizable. On the other hand, in a communication method according to the eighteenth embodiment, APPs and CTSs are finely classified to make differences according to APPs even in the case of the selection of the same CTS occurring in the communication method according to the sixteenth embodiment.

The selection of the time slots CTS at re-transmission is made as shown in table 2.

TABLE 2
Selection Probability (%)

| APP | CTS1 | CTS2 | CTS3 | CTS4 |
|---|---|---|---|---|
| 1 | 60 | 40 | 0 | 0 |
| 2 | 10 | 60 | 30 | 0 |
| 3 | 0 | 50 | 50 | 0 |
| 4 | 0 | 30 | 60 | 10 |
| 5 | 0 | 0 | 40 | 60 |

The table 2 shows that, for example, at re-transmission after collision, a packet having APP=2 selects CTS1 at a probability of 10%, and CTS2 at 60%, CTS3 at 30% and CTS4 at 0%. As obvious from the table 2, as the APP value decreases, that is, with higher priority, the probability of selection of earlier CTS increases.

As an example, we consider the cases that a packet having APP=1 and a packet having APP=2 select time slots CTS.

Probability of a packet having APP=1 being re-transmitted from CTS1

=0.6×(1−0.1)=0.54

Probability of a packet having APP=1 being re-transmitted from CTS2

=0.4×0.3=0.12

That is, the packet having APP=1 can be re-transmitted at a probability of 66%. In this connection, a probability of occurrence of re-collision is 30%, and a probability of a packet having APP=2 being transmitted is 4%. In the case of the above-described sixteenth embodiment, a probability of transmission of a packet having APP=1 is 25%, and a probability of collision is 50%, and further, a probability of transmission of a packet having APP=2 is 25%.

This signifies that, in place of random selection of a collision processing time slot, a probability of selection of an earlier collision processing time slot is increased as an application priority becomes higher, thus making difference according to application priority.

(Nineteenth Embodiment)

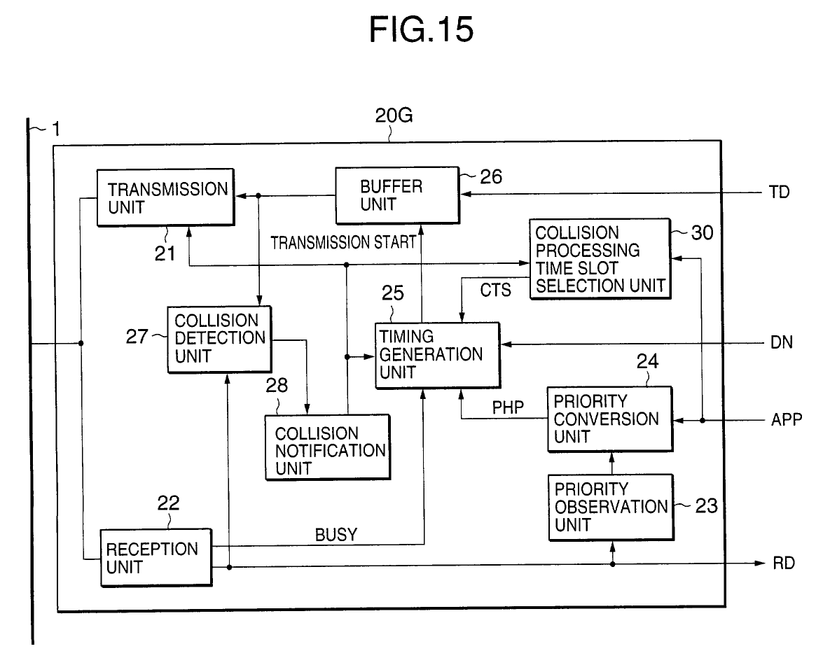

The nineteenth embodiment of the present invention relates to a communication apparatus for realizing the above-described communication method according to the eighteenth embodiment. FIG. 15 is an illustration of an example of a configuration of a communication apparatus 20G according to the nineteenth embodiment.

As FIG. 15 shows, the communication apparatus 20G according to the nineteenth embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing, on the basis of the digital signal outputted from the reception unit 22, the correspondence between a physical priority and application priority of a packet flowing on the transmission line 1, a priority conversion unit 24 for accumulating the results of observations by the priority observation unit 23 at intervals of given period of time to produce and update a conversion table between a physical priority and an application priority for obtaining a corresponding physical priority on the basis of a packet application priority inputted together with transmission packet data from the external and outputting it to a timing generation unit 25, a buffer unit 26 having a function to temporarily retain transmission packet data, a collision detection unit 27 having a function to compare an input signal to the transmission unit 21 and an output signal from the reception unit 22 for, if they do not agree with each other, making a decision to the occurrence of a collision on the transmission line 1 and outputting a collision detection signal, a collision notification unit 28 having a function to output a collision notification signal which is active for a given period of time after the collision detection, and a collision processing time slot selection unit 30 having a function to select a collision processing time slot CTS from which re-transmission is made after collision.

A description will be given hereinbelow of a case in which transmission of a packet having APP=2 starts newly as PHP=2 in a state where a packet having APP=3 is flowing after being converted into PHP=2 according to a conversion table, and a collision occurs.

When a collision notification signal is inputted to the collision processing time slot selection unit 30, the collision processing time slot selection unit 30 notifies, to the timing generation unit 25, a collision processing time slot CTS to be used, on the basis of an APP value through the use of the table 2. In response to the notification therefrom, the timing generation unit 25 outputs a transmission start signal to the buffer unit 26.

After the timing generation unit 25 makes the collision notification signal become non-active, different from the random selection of one of X collision processing time slots, this provides a higher probability that the collision processing time slot selection unit 30 selects an earlier collision processing time slot as the application priority of re-transmission packet becomes higher, thus realizing the communication method according to the eighteenth embodiment.

Depending on network, there is a case of handling information, such as a network control signal or an urgent signal, which is low in occurrence frequency but particularly high in priority. The twentieth to twenty-third embodiments, which will be described later, are employable in such a case, and information having a particularly high priority is transmitted using a packet having APP=1, while other information are transmitted as APP=2 to 5.

(Twentieth Embodiment)

In the above-described embodiments, only a communication apparatus faced with the collision can carry out the transmission immediately after the collision. On the other hand, in the twentieth embodiment, exception processing is conducted in the case of transmission of a packet having APP=1. A communication method according to the twentieth embodiment is basically similar to that of the fourteenth embodiment, but in this embodiment, in a case in which a request for transmission of a packet having APP=1 occurs in one communication apparatus when a collision occurs between other communication apparatus and a jam signal flows on the transmission line 1, the one communication apparatus, as with being involved in collision, selects a collision processing time slot and tries to carry out the transmission.

This provides a possibility of transmitting a packet having APP=1 without waiting for the completion of the packet transmission of a communication apparatus involved in collision.

(Twenty-First Embodiment)

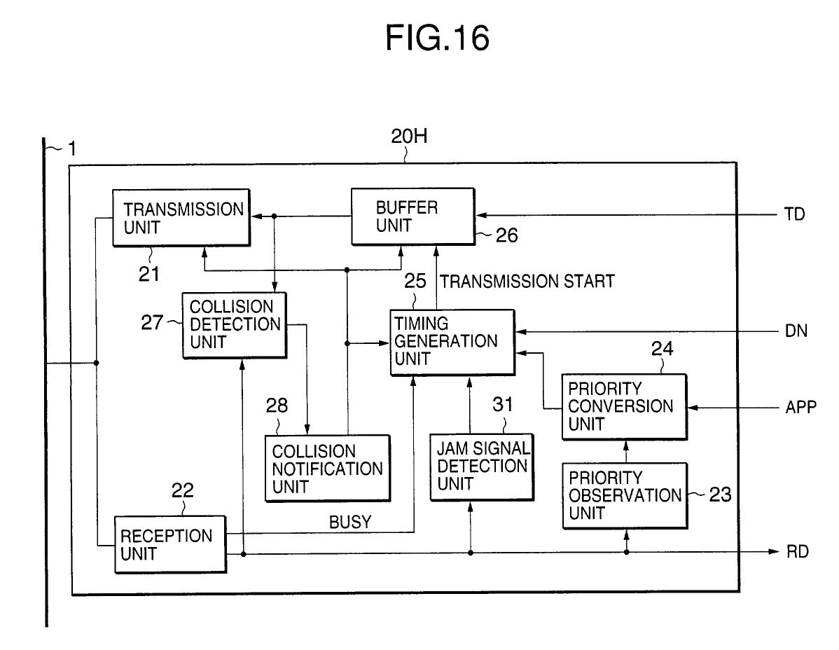

The twenty-first embodiment of the present invention relates to a communication apparatus for realizing the above-described communication method according to the twentieth embodiment. FIG. 16 is an illustration of an example of a configuration of a communication apparatus 20H according to the twenty-first embodiment.

As FIG. 16 shows, the communication apparatus 20H according to the twenty-first embodiment is made of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing, on the basis of the digital signal outputted from the reception unit 22, the correspondence between a physical priority and application priority of a packet flowing on the transmission line 1, a priority conversion unit 24 for accumulating the results of observations by the priority observation unit 23 at intervals of given period of time to produce and update a conversion table between a physical priority and an application priority for obtaining a corresponding physical priority on the basis of an application priority of a packet inputted together with transmission packet data from the external and outputting it to a timing generation unit 25, a buffer unit 26 having a function to temporarily retain transmission packet data, a collision detection unit 27 having a function to compare an input signal to the transmission unit 21 and an output signal from the reception unit 22 for, if they do not agree with each other, making a decision to the occurrence of a collision on the transmission line 1 and outputting a collision detection signal, a collision notification unit 28 having a function to output a collision notification signal which is active for a given period of time after the collision detection, and a jam signal detection unit 31 having a function to detect, on the basis of an output of the reception unit 22, the fact that a jam signal exists on the transmission line 1.

When a jam signal appears on the transmission line 1 due to the occurrence of a collision between other communication apparatus, the jam signal detection unit 31 detects the presence of the jam signal, and makes a jam detection signal active while the jam signal exists and outputs the jam detection signal to the timing generation unit 25. In a case in which a request for transmission of a packet having APP=1 takes place while the jam detection signal is active, the timing generation unit 25 handles the jam detection signal similarly to a collision notification signal, and, after it becomes non-active, outputs transmission start signal to the buffer unit 26 at the timing of a collision processing time slot CTS selected at random. This arrangement can realize the communication method according to the twentieth embodiment.

(Twenty-Second Embodiment)

The communication method according to the twentieth embodiment is for acquiring a transmission right by making a packet having APP=1 compete with another collision packet. On the other hand, a communication method according to the twenty-second embodiment of the present invention is for preferentially and surely transmitting a packet having APP=1.

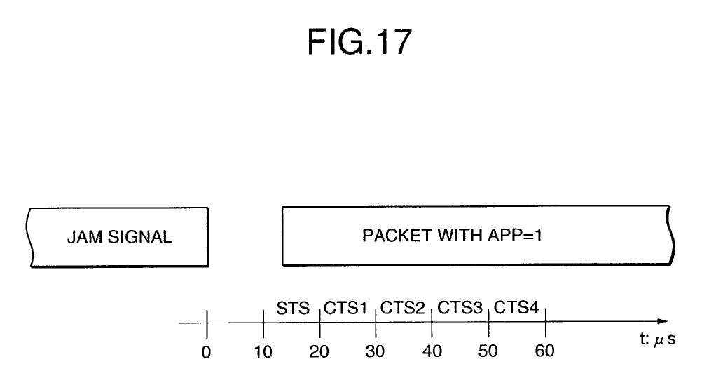

That is, as FIG. 17 shows, in the communication method according to the twenty-second embodiment, after a jam signal, a special time slot STS is located prior to a collision processing time slot CTS. In a case in which a request for transmission of application priority=1 occurs during the reception of a jam signal, although the communication apparatus is not involved in a collision, the communication apparatus carries out the transmission from the aforesaid special time slot.

Although the operation according to this embodiment is basically similar to that of the fourteenth embodiment, if a request for transmission of a packet having APP=1 occurs in one communication apparatus when a collision occurs between other communication apparatus and a jam signal is flowing on the transmission line 1, that packet is transmitted from the special time slot STS. This enables the packet having APP=1 to be transmitted preferentially.

A collision occurs when a plurality of communication apparatus simultaneously gain access to the special time slot STS. In this case, the same processing as the ordinary collision processing is conducted, and each of the communication apparatus acts as a communication apparatus involved in the collision and selects a collision processing time slot. However, they can always transmit the packet prior to a packet having APP≠1 which has caused the first collision.

(Twenty-Third Embodiment)

A basic configuration of a communication apparatus according to a twenty-third embodiment of the present invention is similar to that of the twenty-first embodiment shown in FIG. 16, except for an operation of the timing generation unit 25.

When a collision occurs between other communication apparatus and a jam signal appears on the transmission line 1, the jam signal detection unit 31 detects the jam signal and makes a jam detection signal active while the jam signal exists thereon and outputs it to the timing generation unit 25. When a request for transmission of a packet having APP=1 takes place while the jam detection signal is active, the timing generation unit 25 handles the jam detection signal like a collision notification signal, and outputs a transmission start signal to the buffer unit 26 at the timing of a special time slot STS after the jam detection signal becomes non-active. This realizes the communication method according to the twenty-second embodiment.

The above-described first to twenty-third embodiments relate to communication methods, communication apparatus and communication systems of a distributed control type in which communication apparatus equal in function to each other are connected to one transmission line 1. The following description relates to communication methods, communication apparatus and communication systems made for use in a configuration in which one communication apparatus having a master function and one or more communication apparatus each having a slave function are communicated to the same transmission line. In this case, the communication can be established between the master communication apparatus and the slave communication apparatus and between the slave communication apparatus.

(Twenty-Fourth Embodiment)

The twenty-fourth embodiment of the present invention is made to prescribe a communication method using communication apparatus. As in the case of the communication method according to the first embodiment, the master communication apparatus observes an APP and PHP of a packet flowing on the transmission line at intervals of given period of time to collect the correspondence between the APPs and the PHPs for producing/updating a conversion table. For its own transmission, the communication apparatus itself determines a PHP in accordance with the conversion table. In addition, it immediately converts the conversion table information into a packet form at every production/updating of the conversion table to broadcast it to the slave communication apparatus.

That is, in a communication method of transmitting packets according to a carrier sense multiple access system with a collision detection function between plural communication apparatus each connected to a transmission line of a logically substantial bus type, N (N represents an integer which is two or more) application priorities specified from the external and N physical priorities to be used at actual transmission to the transmission line are set where 1 signifies the highest priority and N signifies the lowest priority, and N priority time slots are set after a packet comes to an end on the transmission line where the time slots are taken as PTS1, PTS2, . . . , PTSN in latening time sequence so that a packet having a physical priority=m (1≦m≦N) has a transmission right on and after a time slot PTSm, and further, one master communication apparatus carries out an observation of the application priority and physical priority of a packet flowing on the transmission line for a given period of time for seizing the correspondence between the application priority and the physical priority, and broadcasts information on conversion from the application priority to the physical priority to another communication apparatus.

(Twenty-Fifth Embodiment)

The twenty-fifth embodiment of the present invention is designed to prescribe a communication method to be used by a slave communication apparatus responding to the master function according to the twenty-fourth embodiment. The slave communication apparatus receives conversion table information converted into a packet form and transmitted from the master communication apparatus and internally restores the conversion table. The conversion an APP into a PHP is made according to this table. The other operation is the same as that in the method according to the first embodiment.

A combination of the twenty-fourth embodiment and the twenty-fifth embodiment can provide the same effects as those of the communication method according to the first embodiment. Moreover, in this method, although the master communication apparatus is required to have, in addition to a traffic observation function, a conversion information transmission function, the slave communication apparatus is not required to carry out the observation, which causes the size reduction and cost reduction of the communication apparatus. Accordingly, for a network to which more slave apparatus are connected, the greater advantage is attainable.

(Twenty-Sixth Embodiment)

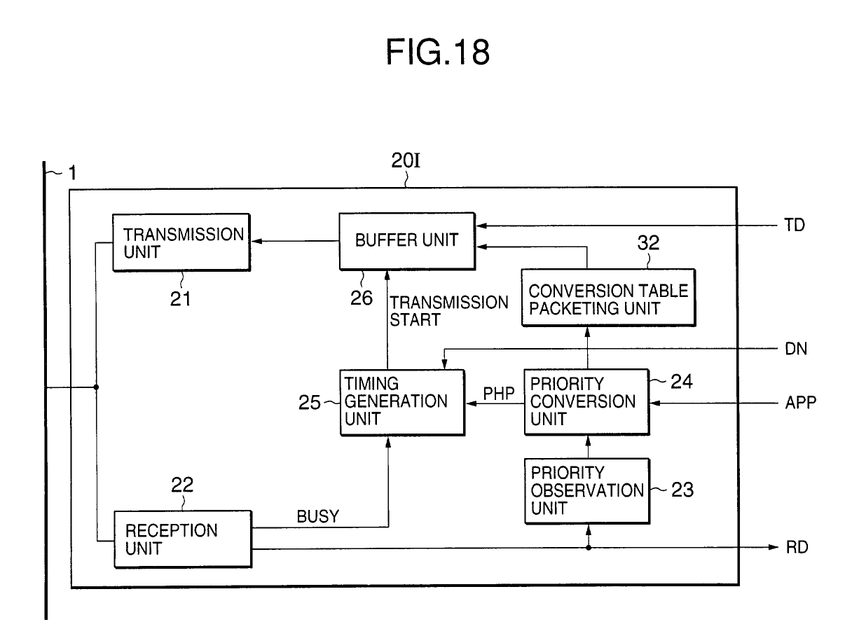

The twenty-sixth embodiment of the present invention relates to a communication apparatus for realizing the communication method according to the twenty-fourth embodiment. FIG. 18 is an illustration of an example of a configuration of a communication apparatus 20I according to the twenty-sixth embodiment.

As FIG. 18 shows, a communication apparatus 20I according to the twenty-sixth embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing, on the basis of the digital signal outputted from the reception unit 22, the correspondence between a physical priority and application priority of a packet flowing on the transmission line 1, a priority conversion unit 24 for accumulating the results of observations by the priority observation unit 23 at intervals of given period of time to produce and update a conversion table between a physical priority and an application priority for obtaining a corresponding physical priority on the basis of an application priority of a packet inputted together with transmission packet data from the external and outputting it to a timing generation unit 25, a buffer unit 26 having a function to temporarily retain transmission packet data, and a conversion table packeting unit 32 serving as a conversion information transmission unit having a function to convert a conversion table in the interior of the priority conversion unit 24 into a packet form and to output it to the buffer unit 26.

An operation of this communication apparatus 20I is almost the same as that of the second embodiment. A difference therebetween is that, when a conversion table in the priority conversion unit 24 is updated, the conversion table packeting unit 32 converts the contents of the new conversion table into a packet form and outputs it to the buffer unit 26. Following this, as well as the ordinary packet transmission, the packet is sent out to the transmission line 1. That packet is set to be addressed to all of the slave communication apparatus. Moreover, the physical priority PHP is set at 1.

For the packeting of the conversion table, all the information can be transmitted through the use of one packet, or they can also be divided into a plurality of packets. However, in general, since the quantity of the information on the conversion table is small, the division produces no advantage.

(Twenty-Seventh Embodiment)

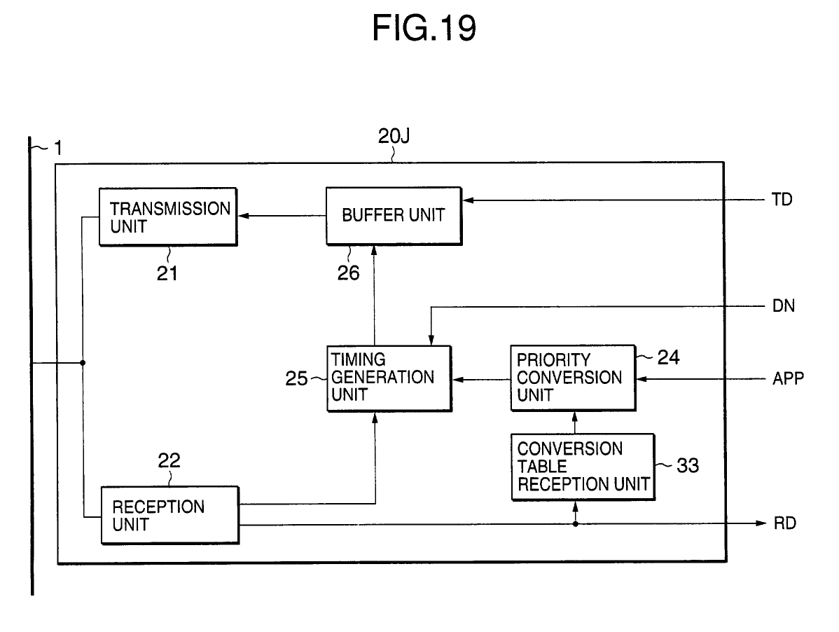

The twenty-seventh embodiment of the present invention relates to a communication apparatus for realizing the communication method according to the twenty-fifth embodiment. FIG. 19 shows an example of a configuration of a communication apparatus 20J according to the twenty-seventh embodiment.

As FIG. 19 shows, a communication apparatus 20J according to the twenty-seventh embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a conversion table reception unit 33 serving as a conversion information reception unit having a function to receive a conversion table information packet sent from a master communication apparatus for restoring a conversion table, a priority conversion unit 24 for obtaining, according to the restored conversion table, a corresponding physical priority on the basis of an application priority of a packet inputted together with transmission packet data from the external and outputting it to a timing generation unit 25, and a buffer unit 26 having a function to temporarily retain transmission packet data.

An operation of this communication apparatus is almost the same as the operation according to the second embodiment. A difference therebetween is that itself has no function to carry out the observation of a traffic for acquiring a conversion table.

Upon receipt of a conversion table information packet from a master apparatus, the conversion table reception unit 33 derives information from that packet and transfers it to the priority conversion unit 24. At this time, if the form of the input interface of the priority conversion unit 24 is made to be the same as that of the conversion table reception unit 33, the circuits are standardized with respect to the master communication apparatus.

(Twenty-Eighth Embodiment)

If one master communication apparatus according to the twenty-fifth embodiment and one or more slave communication apparatus according to the twenty-seventh embodiment are connected to the same transmission line, all of the communication apparatus can share a conversion table produced by the master communication apparatus, which efficiently achieves packet communications in which a priority is attached to transmission information. Since the conversion table is originally one in number, a possibility that the communication apparatus have different conversion tables in error becomes lower, and in a case in which a higher-efficiency conversion algorithm has been developed after the start of operation of a network, the entire network can handle the new algorithm through an alteration of only the master communication apparatus.

(Twenty-Ninth Embodiment)

In a case in which the contents of a conversion table are as shown in the table 1, when one communication apparatus tries to transmit a packet having APP=3, the transmission is started as PHP=3 in this case. As a result, the same PHP is allocated with respect to different APP values until the conversion table is updated, resulting in incorrect allocation of priorities. Therefore, if observing that packets having a plurality of APPs with respect to one PHP are flowing on the transmission line, the master communication apparatus using this communication method immediately updates the conversion table and broadcasts the contents thereof to the slave apparatus. For example, in the above-mentioned example, the conversion table is updated as shown in table 3, thereby making appropriate conversion tables in all the communication apparatus at all times.

TABLE 3

| APP | PHP |
|---|---|
| 1 | 1 |
| 2 | 2 |
| 3 | 3 |
| 5 | 4 |

(Thirtieth Embodiment)

The thirtieth embodiment of the present invention relates to a communication apparatus for realizing the communication method according to the twenty-ninth embodiment. A configuration of a communication apparatus according to the thirtieth embodiment is the same as that according to the twenty-sixth and an operation thereof is basically similar to that of the twenty-sixth embodiment, except for an operation of the priority conversion unit 24.

The priority conversion unit 24 similarly updates the contents of the conversion table at intervals of given period of time, but seeing the information from the priority observation unit 23 and immediately updating the conversion table if detecting that packets having different application priorities with respect to one physical priority are flowing on the transmission line 1. For example, in a case in which a packet having APP=3 is detected as PHP=3 with respect to the table 1 which is the present conversion table, the conversion table is immediately updated as shown in the table 3. In response to this, the conversion table packeting unit 32 converts the contents of the conversion table into a packet form and outputs it.

That is, in operation, the conversion table packeting unit 32, when the conversion table is updated, sends out the contents thereof. Therefore, the same operation is also employable in the twenty-sixth embodiment or in the thirtieth embodiment.

(Thirty-First Embodiment)

In a case in which users of a network are fixed, it is considered that the using situations thereof, such as day, week, year and others, have given patterns. The thirty-first embodiment of the present invention is made to handle such periodic variations.

For example, let it be assumed that a statistical result for one previous day is as shown in table 4.

TABLE 4

| | Number of Packets | | | | |
|---|---|---|---|---|---|
| Time Zone | APP = 1 | APP = 2 | APP = 3 | APP = 4 | APP = 5 |
| 0.00-1:00 | 0 | 401 | 56 | 714 | 1229 |
| 1:00-2:00 | 2 | 64 | 133 | 298 | 672 |
| . | . | . | . | . | . |
| . | . | . | . | . | . |
| . | . | . | . | . | . |
| 15:00-16:00 | 2031 | 13069 | 885 | 4130 | 6931 |
| 16:00-17:00 | 3180 | 9617 | 1644 | 3912 | 8086 |

Taking note of the time zone from 15:00 to 16:00, it is found that a large number of packets having APP=2 exist. However, viewing in units of minute, there is a possibility that no packets having APP=2 flow. At this time, if a packet having APP=4 is allocated to PHP=2, the probability that a packet having APP=2 appears becomes high during the ensuing minute, which can cause useless collisions and lower the transmission efficiency. Therefore, in such a case, a reservation is made such that, to a PHP corresponding to APP=2, an APP lower in priority than it is not allocated for a period of time from 15:00 to 16:00. This prevents the useless collision.

A description will be given hereinbelow of a concrete example of an operation. Let it be assumed that a conversion table immediately before 15:00 is as shown in table 5. An APP=2 is reserved at 15:00. As a result, the conversion table becomes as shown in table 6. In the table 6, a mark * represents a reserved APP. Thus, since a packet having APP=2 can always be transmitted in preference to a packet having APP=3 or lower priorities, there is no occurrence of a collision against lower-priority packets.

TABLE 5

| Reservation | APP | PHP |
|---|---|---|
| | 1 | 1 |
| | 4 | 2 |

TABLE 6

| Reservation | APP | PHP |
|---|---|---|
| | 1 | 1 |
| * | 2 | 2 |
| | 4 | 3 |

In the above description, for simplicity of explanation only, the operations for the next day have been prescribed on the basis of the result obtained for one day. However, in general, since the traffic has many changing elements, such the allocation is actually made on the basis of the statistical data obtained during several days or more.

(Thirty-Second Embodiment)

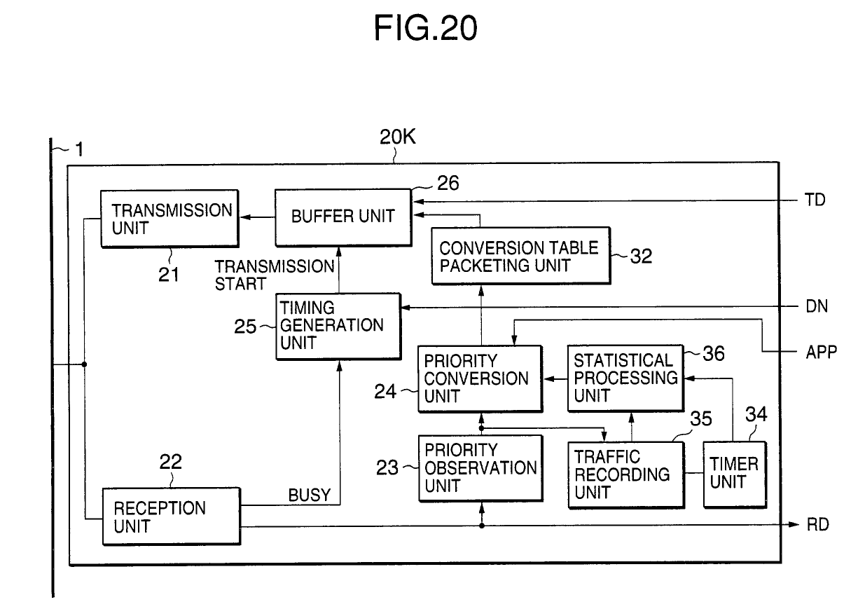

The thirty-second embodiment of the present invention relates to a master communication apparatus for realizing the method according to the thirty-first embodiment. FIG. 20 is an illustration of an example of a configuration according to the thirty-second embodiment.

As FIG. 20 shows, a communication apparatus 20K according to the thirty-second embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing the correspondence between a physical priority and application priority of a packet flowing on the transmission line 1 on the basis of the digital signal outputted from the reception unit 22, a traffic recording unit 35 having a function to record the observation result by the priority observation unit 23 together with the present time given by a timer unit 34, a statistical processing unit 36 having a function to obtain the number of packets on the basis of the contents recorded by the traffic recording unit 35 for each APP at intervals of one hour and further to, when the obtained number of packets exceeds a prescribed value, output this fact to a priority conversion unit 24 at a relevant time, a buffer unit 26 having a function to temporarily retain transmission packet data, and a conversion table packeting unit 32 having a function to convert a conversion table in the interior of the priority conversion unit 24 into a packet form and to output it to the buffer unit 26.

In operation, when detecting an APP value and PHP value of a packet flowing on the transmission line 1, the priority observation unit 23 reads the time of the reception of that packet from the timer unit 34 to record the time thereof together with these contents in the traffic recording unit 35 one after another. When the data recorded for one day (24 hours) are accumulated, the statistical processing unit 36 totalizes the number of packets for each APP at intervals of one hour. At this time, if the number of packets exceeds a predetermined prescribed value (for example, 10,000), the information on this is notified to the priority conversion unit 24. The priority conversion unit 24 reserves the notified APP so as not to assign an APP lower in priority than this APP to the PHP corresponding thereto. The operation of this section is conducted according to the communication method according to the thirty-first embodiment. This arrangement can provide a communication apparatus for realizing the communication method according to the thirty-first embodiment.

Incidentally, since the conversion table packeting unit 32 converts a conversion table reflective of reservation into a packet form, the communication apparatus according to the twenty-fifth embodiment is directly employable as a slave communication apparatus.

(Thirty-Third Embodiment)

If packets having one APP appears intensively, collisions occur frequently at PTSs corresponding thereto. The thirty-third embodiment of the present invention is for the purpose of reducing such collisions.

Let it be assumed that the present conversion table is the table 1. At this time, if collisions occur frequently in the case of APP=2 (that is, PTS2), a master communication apparatus assigns a plurality of PHPs with respect to APP=2 as shown in table 7.

In a case in which a master communication apparatus transmits a packet having APP=2, the PHP is randomly selected to be 2 or 3.

(Thirty-Fourth Embodiment)

If receiving a conversion table in which a plurality of PHPs are assigned with respect to one APP, a slave communication apparatus, when transmitting a packet having this APP, randomly selects one of the assigned PHPs. For example, when receiving the conversion table shown in the table 7, for the APP=2 transmission, the slave communication apparatus selects one of 2 and 3 at random (that is, with a probability of ½).

TABLE 7

| APP | PHP |
|---|---|
| 1 | 1 |
| 2 | 2 |
| 2 | 3 |
| 5 | 4 |

By implementing the communication methods according to the thirty-third and thirty-fourth embodiments, in the case of the example shown in the table 7, since a packet having APP=2 is assigned to PHP=2 or 3, the number of packets having PHP=2 is reduced to approximately half, thus reducing the possibility of collision. The collision lowers the transmission efficiency and, hence, the communication method according to this embodiment can improve the efficiency.

(Thirty-Fifth Embodiment)

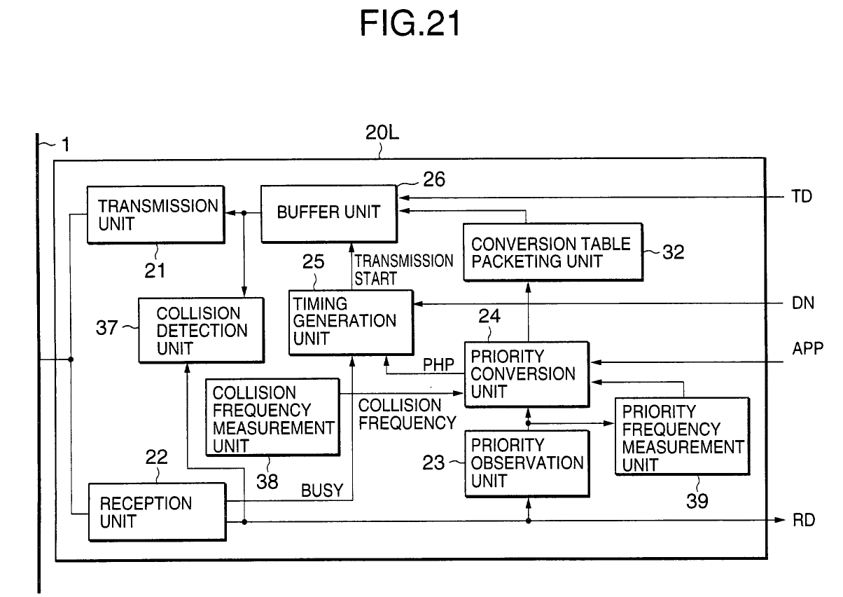

FIG. 21 shows an example of a configuration of a communication apparatus according to the thirty-fifth embodiment of the present invention.

As FIG. 21 shows, a communication apparatus 20L according to the thirty-fifth embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing the correspondence between a physical priority and application priority of a packet flowing on the transmission line 1 on the basis of the digital signal outputted from the reception unit 22, a priority conversion unit 24 for accumulating the results of observations by the priority observation unit 23 at intervals of given period of time to produce and update a conversion table between a physical priority and an application priority for obtaining a corresponding physical priority on the basis of an application priority of a packet inputted together with transmission packet data from the external and outputting it to a timing generation unit 25, a buffer unit 26 having a function to temporarily retain transmission packet data, a conversion table packeting unit 32 having a function to convert a conversion table in the interior of the priority conversion unit 24 into a packet form and to output it to the buffer unit 26, a collision detection unit 37 having a function to compare an input signal to the transmission unit 21 and an output signal from the reception unit 22 for, if they do not agree with each other, outputting a collision detection signal, a collision frequency measurement unit 38 having a function to count the number of times of collision occurring in a unit time (for example, 1 s), and a priority frequency measurement unit 39 for measuring the number of packets for each APP, flowing on the transmission line 1, for a given period of time.

The ordinary operation in this embodiment is the same as that of the twenty-fifth embodiment, and the description thereof will be omitted for brevity.

If packet collisions occur frequently on the transmission line 1 and when the frequency thereof exceeds a predetermined value, the collision frequency measurement unit 38 issues a collision frequency notification signal. Meanwhile, the priority frequency measurement unit 39 observes a frequency of appearance of packets for each APP to examine the APP of packets flowing most frequently on the transmission line 1. When the collision frequency notification signal is given to the priority conversion unit 24, the priority conversion unit 24 reads the most flowing APP value from the priority frequency measurement unit 39, and assigns consecutive two PHPs with respect to that APP.

For example, in a state where the conversion table is the table 1, if collisions occur frequently and the priority frequency measurement unit 39 indicates that the packets having APP=2 have the most frequency, the conversion table is rewritten as shown in the table 7. Following this, for the transmission of a packet having APP=2, the communication apparatus 20L randomly selects PHP=2 or 3. Moreover, when the conversion table is rewritten, the conversion table packeting unit 32 converts the information about the rewriting into a packet form and transmits it to a slave communication apparatus. This can realize the communication method according to the thirty-third embodiment.

(Thirty-Sixth Embodiment)

A configuration of a communication apparatus according to a thirty-sixth embodiment of the present invention is the same as that of the twenty-seventh embodiment shown in FIG. 19, except for a portion of the operation of the priority conversion unit 24. Upon setting of a conversion table in which a plurality of PHPs are assigned with respect to one APP, for determining a PHP with respect to this APP, the priority conversion unit 24 selects one from a plurality of PHPs at random. This can realize the communication method according to the thirty-fifth embodiment.

The above-described communication methods are made to permit the transmission of a low-priority packet after the completion of the transmission of a high-priority packet. Accordingly, if packets having high priorities appear successively, the low-priority packet(s) cannot be transmitted indefinitely. In the actual network, even a low-priority packet is required to be transmitted without waiting for an indefinite time. On the other hand, in some cases, a high-priority packet can also accept a slight delay. A communication method according to this embodiment is effective in such cases. This is applicable not only to distributed control type communication methods according to the twenty-third embodiment and the embodiments described previously to it, but also to the master/slave type communication methods according to the embodiments described after the twenty-third embodiment.

(Thirty-Seventh Embodiment)

Let it be assumed that the present conversion table is the table 3. At this time, if a large number of packets having APP=2 or 3 appear to occupy the transmission line, the transmission of a packet having APP=5 becomes difficult. In a case in which there is no chance of transmission although waiting for a given period of time, the communication apparatus according to the present invention, which tries to transmit a packet having APP=5, raise the PHP of this packet by one step. That is, the content of the conversion table becomes as shown in table 8. Thus, even a packet having APP=5 can have a transmission chance equal to that of a packet having APP=3.

TABLE 8

| APP | PHP |
|---|---|
| 1 | 1 |
| 2 | 2 |
| 3 | 3 |
| 5 | 3 |

In a case in which the above-mentioned concept is further developed, the PHP can further be raised if the transmission is difficult for a given period of time.

Incidentally, in the case of the conversion of a PHP into a higher PHP, the PHP is returned to the original priority after the completion of the transmission of one packet.

(Thirty-Eighth Embodiment)

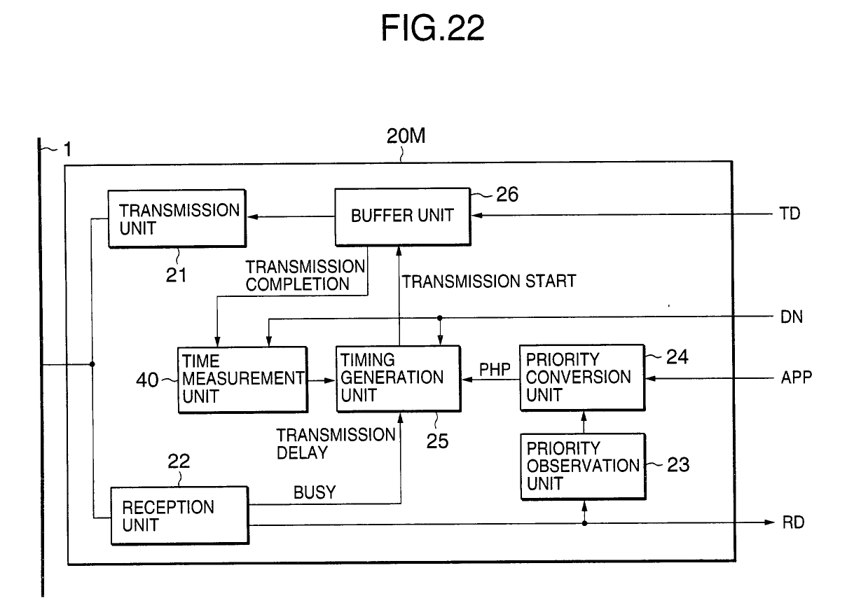

The thirty-eighth embodiment of the present invention relates to a communication apparatus for realizing the communication method according to the thirty-seventh embodiment. FIG. 22 is an illustration of a configuration of a communication apparatus according to the thirty-eighth embodiment of the present invention.

As FIG. 22 shows, a communication apparatus 20M according to the thirty-eighth embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, issue a busy signal and receive that signal for conversion into a digital signal, a priority observation unit 23 for observing the correspondence between a physical priority and application priority of a packet flowing on the transmission line 1 on the basis of the digital signal outputted from the reception unit 22, a priority conversion unit 24 for accumulating the results of observations by the priority observation unit 23 at intervals of given period of time to produce and update a conversion table between a physical priority and an application priority for obtaining a corresponding physical priority on the basis of an application priority of a packet inputted together with transmission packet data from the external and outputting it to a timing generation unit 25, a buffer unit 26 having a function to temporarily retain transmission packet data, and a time measurement unit 40 having a function to start the measurement of time at the time of input of a completion signal DN and to, if a transmission completion notification is not made from the buffer unit 26 until a given period of time (for example, 1 s) elapses, output a transmission delay notification signal to a timing generation unit 25.

The ordinary operation of the communication apparatus 20M is similar to that of the communication apparatus according to the second embodiment.

A description will be given hereinbelow of an operation in a state where the transmission line 1 is used exclusively by packets having high priorities.

In a case in which the conversion table is the table 3, when transmission packet data having APP=5 is inputted and a write completion signal is inputted, the time measurement unit 40 starts the time measurement. Although the timing generation unit 25 attempts to output a transmission start signal at the timing of a PHP specified, that is, at the time slot PTS4, since the busy signal from the reception unit 22 becomes active before it, difficulty is encountered in outputting the transmission start signal. If a given period of time elapses as it stands, the time measurement unit 40 outputs a transmission delay notification signal to the timing generation unit 25. Upon receipt of the transmission delay notification signal, the timing generation unit 25 attempts transmission at the timing of the time slot PTS3. Thus, the priority apparently becomes higher, which enhances the possibility of the packet transmission.

Although collision is omitted from the description, in the actual communication apparatus, a collision occurs at the time slot PTS3, thereafter entering into re-transmission process. At this time, a possibility for the transmission develops.

(Thirty-Ninth Embodiment)

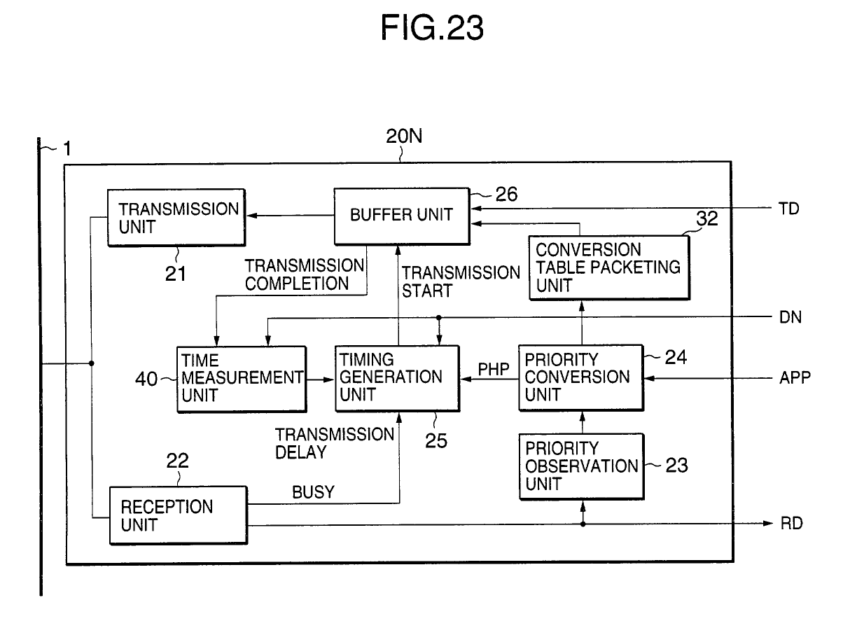

The thirty-ninth embodiment of the present invention relates to a communication apparatus for realizing the communication method according to the thirty-seventh embodiment. FIG. 23 shows a configuration of a communication apparatus according to the thirty-ninth embodiment.

As FIG. 23 shows, a communication apparatus 20N according to the thirty-ninth embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, receive that signal for conversion into a digital signal, a priority observation unit 23 for observing the correspondence between a physical priority and application priority of a packet flowing on the transmission line 1 on the basis of the digital signal outputted from the reception unit 22, a priority conversion unit 24 for accumulating the results of observations by the priority observation unit 23 at intervals of given period of time to produce and update a conversion table between a physical priority and an application priority for obtaining a corresponding physical priority on the basis of an application priority of a packet inputted together with transmission packet data from the external and outputting it to a timing generation unit 25, a buffer unit 26 having a function to temporarily retain transmission packet data, a time measurement unit 40 having a function to start the measurement of time at the time of input of a completion signal DN and to, if a transmission completion notification is not made from the buffer unit 26 before the elapse of a given period of time (for example, 1 s), output a transmission delay notification signal to a timing generation unit 25, and a conversion table packeting unit 32 for converting a conversion table in the interior of the priority conversion unit 24 into a packet form to output it to the buffer unit 26.

An operation of the communication apparatus 20N is almost the same as that of the communication apparatus according to the thirty-eighth embodiment. However, this apparatus operates as a master communication apparatus, that is, includes a function to carry out the packeting of a conversion table and transmission. This function is the same as that of the communication apparatus according to the twenty-fifth embodiment.

(Fortieth Embodiment)

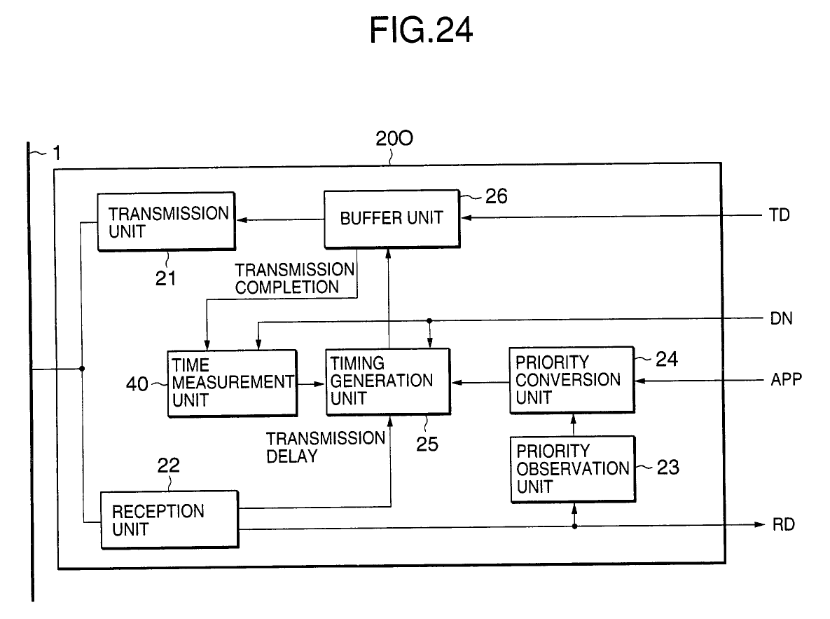

The fortieth embodiment of the present invention relates to a communication apparatus for realizing the communication method according to the thirty-seventh embodiment. FIG. 24 shows a configuration of a communication apparatus according to the fortieth embodiment.

As FIG. 24 shows, a communication apparatus 20O according to the fortieth embodiment is made up of a transmission unit 21 having a function to convert an inputted digital signal into a signal having a form suitable for transmission and to send it out to a transmission line 1, a reception unit 22 having a function to check whether or not a signal exists on the transmission line 1 and to, if it exists on the transmission line 1, receive that signal for conversion into a digital signal, a conversion table reception unit 23 for receiving a conversion table information packet sent from a master communication apparatus to restore a conversion table, a priority conversion unit 24 for obtaining, according to the restored conversion table, a corresponding physical priority on the basis of a packet application priority inputted together with transmission packet data from the external and outputting it to a timing generation unit 25, a buffer unit 26 having a function to temporarily retain transmission packet data, and a time measurement unit 40 having a function to start the measurement of time at the time of input of a completion signal DN and to, if a transmission completion notification is not made from the buffer unit 26 before the elapse of a given period of time (for example, 1 s), output a transmission delay notification signal to a timing generation unit 25.

An operation of the communication apparatus 20O is almost the same as that of the communication apparatus according to the thirty-eighth embodiment. However, this apparatus operates as a slave communication apparatus, that is, includes a function to receive a conversion table information packet sent from a master communication apparatus for restoring a conversion table. This function is the same as that of the communication apparatus according to the twenty-seventh embodiment.

(Forty-First And Forty-Fifth Embodiments)

A communication method according to the forty-first embodiment of the present invention is made to carry out the sixth and eighth embodiments simultaneously. In this case, an arrangement of a packet is made as shown in FIG. 6.

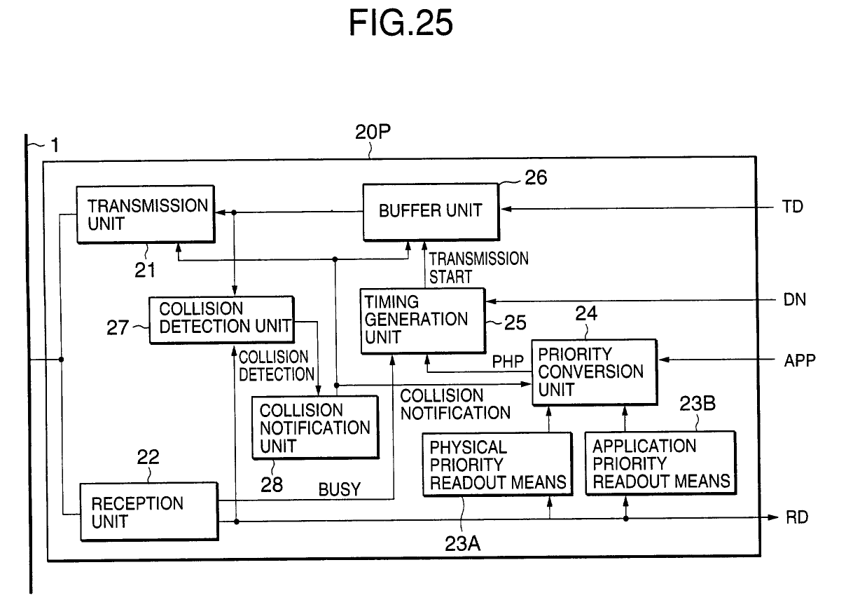

FIG. 25 shows a configuration of a communication apparatus 20P according to the forty-fifth embodiment. In this configuration, of the components of the communication apparatus 20B according to the seventh embodiment shown in FIG. 9, the priority observation unit 23 is replaced with the arrangement according to the ninth embodiment shown in FIG. 7. The outline of the operation thereof is a simple combination of the operations of the seventh and ninth embodiments.

(Forty-Second And Forth-Sixth Embodiments)

A communication method according to the forty-second embodiment of the present invention is made to carry out the sixth and twelfth embodiments simultaneously. In this case, an arrangement of a packet is made as shown in FIG. 6.

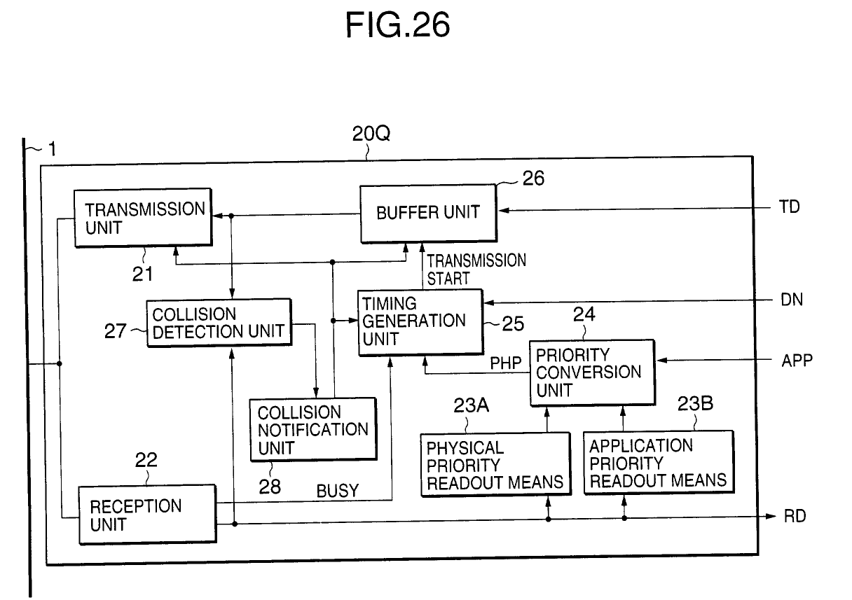

FIG. 26 shows a configuration of a communication apparatus 20Q according to the forty-sixth embodiment. In this configuration, of the components of the communication apparatus 20D according to the thirteenth embodiment shown in FIG. 12, the priority observation unit 23 is replaced with the arrangement according to the ninth embodiment shown in FIG. 7. The outline of the operation thereof is a simple combination of the operations of the seventh and thirteenth embodiments.

(Forty-Third And Forty-Seventh Embodiments)

A communication method according to the forty-third embodiment of the present invention is made to carry out the sixth, twelfth and twentieth embodiments simultaneously. In this case, an arrangement of a packet is made as shown in FIG. 6.

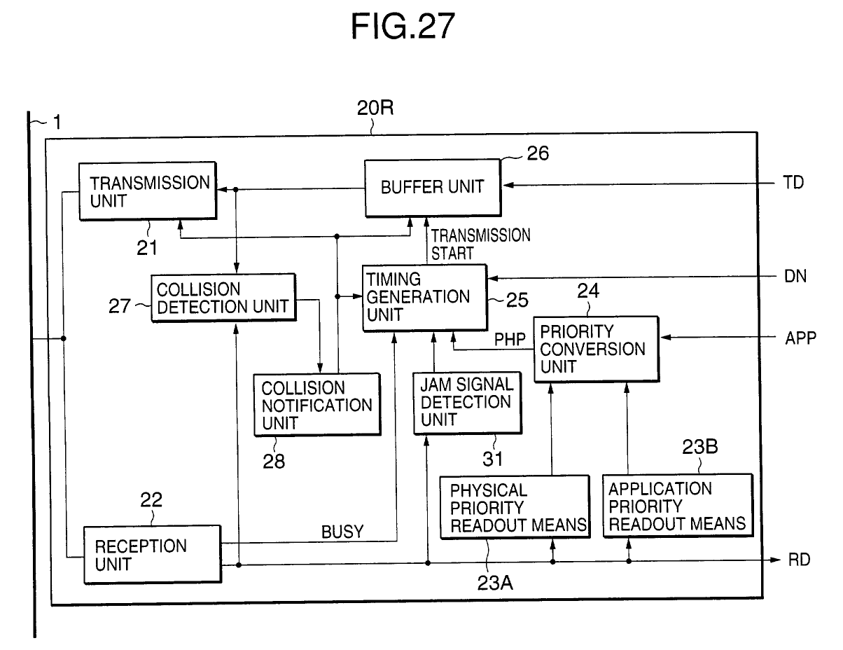

FIG. 27 shows a configuration of a communication apparatus 20R according to the forty-seventh embodiment. In this configuration, the jam signal detection unit 31 shown in FIG. 16 is added to the configuration of the communication apparatus 20Q according to the forty-sixth embodiment shown in FIG. 26. The outline of the operation thereof is a simple combination of the operations of the forty-seventh and twenty-first embodiments.

(Forty-Fourth and Forty-Eighth Embodiments)

A communication method according to the forty-fourth embodiment of the present invention is made to carry out the sixth, eighth and twenty-ninth embodiments simultaneously. In this case, an arrangement of a packet is made as shown in FIG. 6.

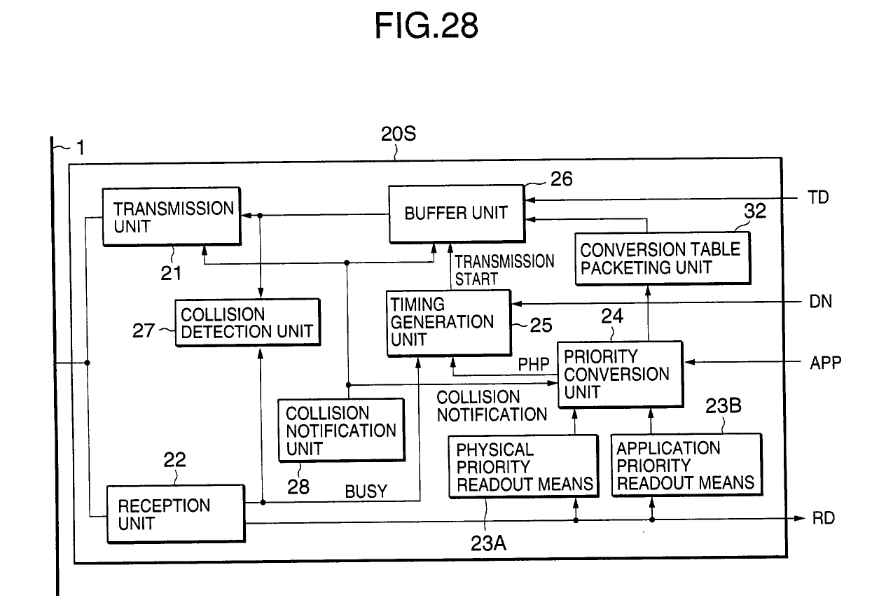

FIG. 28 shows a configuration of a communication apparatus 20S according to the forty-eighth embodiment. In this configuration, of the components of the communication apparatus 20I according to the twenty-sixth embodiment shown in FIG. 18, the priority observation unit 23 is replaced with the arrangement according to the ninth embodiment shown in FIG. 7, and the collision detection unit 27 and the collision notification unit 28 according to the ninth embodiment shown in FIG. 9 are added to the configuration of the communication apparatus 20I according to the twenty-sixth embodiment shown in FIG. 18. The outline of the operation thereof is a simple combination of the operations of the seventh, ninth and twenty-sixth embodiments.

As described above, the timings of transmission are shifted according to priorities of transmission packets so that a packet having a higher priority is transmitted more preferentially. This enables various kinds of application information to be transmitted through a single network, and suppresses the drop of the network efficiency, thus providing excellent communication methods, communication apparatus and communication systems capable of utilizing the transmission line effectively while enabling the communications of packets according to priority.

It should be understood that the present invention is not limited to the above-described embodiments, and that it is intended to cover all changes and modifications of the embodiments of the invention herein which do not constitute departures from the spirit and scope of the invention.

What is claimed is:

1. A communication method of transmitting a packet according to a carrier sense multiple access system with a collision detection function between plural communication apparatus each connected to a transmission line of a logically substantial bus type, comprising the steps of:
setting N (N represents an integer equal to or more than two) application priorities specified from the external and N physical priorities to be used at actual transmission to said transmission line where 1 signifies the highest priority and N signifies the lowest priority;
setting N priority time slots after a packet comes to an end on said transmission line where said time slots are taken as PTS1, PTS2, . . . , PTSN in latening time sequence so that a packet having a physical priority=m (1≦m≦N) has a transmission right on and after a time slot PTSm;
carrying out an observation of said application priority and physical priority of a packet flowing on said transmission line for a given period of time for seizing the correspondence between said application priority and said physical priority;
setting, as a physical priority for a packet to be transmitted from one apparatus itself, a physical priority lower by one rank than a physical priority of a packet having an application priority higher than an application priority of said packet to be transmitted from the one apparatus;
setting said physical priority at 1 when a packet having an application priority higher than the application priority of said packet to be transmitted from the one apparatus does not exist on said transmission line; and
updating a conversion rule for said physical priority and said application priority at intervals of the given time period of the priority observation.

2. A communication apparatus comprising:
a transmission unit having a function to convert an inputted digital signal into a signal having a form suitable for transmission and to send out the converted signal to a transmission line;
a reception unit having a function to check whether or not a signal exists on said transmission line and to, if said signal exists thereon, issue a busy signal and receive said signal existing on said transmission line for converting said signal into a digital signal;
a priority observation unit for observing the correspondence between a physical priority and application priority of a packet flowing on said transmission line on the basis of said digital signal outputted from said reception unit;
a priority conversion unit for accumulating the results of observations by said priority observation unit at intervals of given period of time to produce/update a conversion table between a physical priority and an application priority for obtaining a corresponding physical priority on the basis of a packet application priority inputted together with transmission packet data from the external;
a buffer unit having a function to temporarily retain transmission packet data; and
a timing generation unit for detecting that a packet comes to an end on said transmission line and that said busy signal is non-active and for, when a timing of a priority time slot corresponding to a physical priority notified from said priority conversion unit is reached after the time that said packet comes to an end on said transmission line, sending a transmission start signal to said buffer unit so that said buffer unit sends out the retained transmission packet data to said transmission unit in accordance with said transmission start signal therefrom.

3. A communication system in which a communication apparatus defined in claim 2 is connected to a transmission line of a logically substantial bus type.

4. The communication method according to claim 1, wherein said physical priority of said packet flowing on said transmission line is observed from a position of a priority time slot being put to use.

5. The communication apparatus according to claim 2, wherein said priority observation unit includes:
packet end detection means for detecting a timing of an end of a packet;
packet start detection means for detecting a timing of a start of the next packet;
time measurement means for obtaining a time interval between one packet and the next packet;
a physical priority judgment means for obtaining a physical priority value on the basis of said time interval from said time measurement means to output the obtained physical priority value to said priority conversion unit; and
an application priority readout means for outputting, to said priority conversion unit, an application priority read out from a received packet.

6. The communication method according to claim 1, wherein an area is provided in a packet flowing on said transmission line to store a physical priority of said packet, and for the observation of said physical priority, at transmission of said packet, said physical priority is written in said area while, at reception of said packet, a value indicative of said physical priority is read out from said area.

7. The communication apparatus according to claim 2, wherein said priority observation unit includes:
physical priority readout means for reading out a physical priority from a received packet to output the read physical priority to said priority conversion unit; and
application priority readout means for reading out an application priority from the received packet to output the read application priority to said priority conversion unit.

8. The communication method according to claim 1, wherein when the occurrence of a collision of a packet transmitted onto said transmission line is detected, a jam signal is outputted to notify the occurrence of the collision to all of said communication apparatus for a given period of time, and re-transmission is then made in a state where said physical priority is set to be equal to said application priority.

9. The communication apparatus according to claim 2, further comprising:
a collision detection unit for comparing an input signal to said transmission unit with an output signal from said reception unit to, if the comparison result indicates that they do not agree with each other, making a decision to the occurrence of a collision on said transmission line and outputting a collision detection signal; and
a collision notification unit for outputting a collision notification signal which is active for a given period of time after the collision detection,
when receiving said collision detection signal, said collision notification unit sending said collision notification signal to said transmission unit,
said transmission unit outputting a jam signal to said transmission line while said collision notification signal is active, and
when receiving said collision notification signal, said priority conversion unit temporarily changing a priority conversion for said transmission packet, and notifying a physical priority equal to said application priority to said timing generation unit so that a re-transmission packet is transmitted with said physical priority equal to said application priority.

10. The communication method according to claim 1, wherein, upon detection of the occurrence of a collision of a packet transmitted onto said transmission line, a jam signal is outputted for a given period of time to notify the occurrence of the collision to all of said communication apparatus, and re-transmission of said packet is made in a manner that one of a value of an application priority of said packet undergoing the collision and a value higher by one rank than said value of said application priority is randomly selected and used as a physical priority for the re-transmission.

11. The communication apparatus according to claim 2, further comprising:
a collision detection unit for comparing an input signal to said transmission unit with an output signal from said reception unit to, if the comparison result indicates that they do not agree with each other, making a decision to the occurrence of a collision on said transmission line and outputting a collision detection signal; and
a collision notification unit for outputting a collision notification signal which is active for a given period of time after the collision detection,
when receiving said collision detection signal, said collision notification unit sending said collision notification signal to said transmission unit,
said transmission unit outputting a jam signal to said transmission line while said collision notification signal is active, and
in a case in which a physical priority higher than an application priority is assigned to the transmission packet involved in the collision, when receiving said collision notification signal, said priority conversion unit temporarily changing a priority conversion for said transmission packet, and randomly selecting one of a value of an application priority of said packet undergoing the collision and a value higher by one rank than said value of said application priority and notifying the selected value to said timing generation unit for transmission of a re-transmission packet.

12. The communication method according to claim 1, wherein, upon detection of the occurrence of a collision of a packet transmitted onto said transmission line, a jam signal is outputted for a given period of time to notify the occurrence of the collision to all of said communication apparatus, and X (X represents an integer equal to or more than two) collision processing time slots are then provided where said time slots are taken as CTS1, CTS2, . . . , CTSX in latening time sequence, and said communication apparatus involved in the collision randomly selects one of said collision processing time slots for re-transmission.

13. The communication apparatus according to claim 2, further comprising:
a collision detection unit for comparing an input signal to said transmission unit with an output signal from said reception unit to, if the comparison result indicates that they do not agree with each other, making a decision to the occurrence of a collision on said transmission line and outputting a collision detection signal; and
a collision notification unit for outputting a collision notification signal which is active for a given period of time after the collision detection,
when receiving said collision detection signal, said collision notification unit sending said collision notification signal to said transmission unit and said timing generation unit,
said transmission unit outputting a jam signal to said transmission line while said collision notification signal is active, and
after said collision notification signal becomes non-active, said timing generation unit randomly selecting one of X collision processing time slots and outputting a re-transmission start signal to said buffer unit at a timing of the selected collision processing time slot.

14. The communication method according to claim 1, wherein wherein, upon detection of the occurrence of a collision of a packet transmitted onto said transmission line, a jam signal is outputted for a given period of time to notify the occurrence of the collision to all of said communication apparatus, and X (X represents an integer equal to or more than two) collision processing time slots are then provided where said time slots are taken as CTS1, CTS2, . . . , CTSX in latening time sequence, and said communication apparatus involved in the collision randomly selects one of said collision processing time slots and makes re-transmission, and if a collision occurs at the re-transmission, increases the number of collision processing time slots to Y larger in number than X and randomly selects one of said collision processing time slots for re-transmission.

15. The communication apparatus according to claim 2, further comprising:
a collision detection unit for comparing an input signal to said transmission unit with an output signal from said reception unit to, if the comparison result indicates that they do not agree with each other, making a decision to the occurrence of a collision on said transmission line and outputting a collision detection signal;
a collision notification unit for outputting a collision notification signal which is active for a given period of time after the collision detection; and
a re-transmission count unit for incrementing a count value whenever receiving a re-transmission notification from said timing generation unit and to reset the count value when receiving a notification representative of the completion of a normal transmission from said buffer unit,
when receiving said collision detection signal, said collision notification unit sending said collision notification signal to said transmission unit and said timing generation unit,
said transmission unit outputting a jam signal to said transmission line while said collision notification signal is active,
after said collision notification signal becomes non-active, said timing generation unit randomly selecting one of X collision processing time slots when the count value of said re-transmission count unit indicates zero and randomly selecting one of Y collision processing time slots when indicating one or more for outputting a re-transmission start signal to said buffer unit at a timing of the selected collision processing time slot,
upon receipt of said re-transmission start signal, said buffer unit re-transmitting a packet, and
said re-transmission count unit incrementing the count value by one, and if transmission of the re-transmission packet reaches completion without encountering a collision, resetting the count value to zero.

16. The communication method according to claim 12, wherein, in place of the random selection of said collision processing time slot, in the case of transmission of a packet having an application priority higher than N/2, a collision processing time slot having a number larger than X/2 is selected, and in the case of transmission of a packet having an application priority equal to or below N/2, a collision processing time slot having a number equal or below X/2 is selected.

17. The communication apparatus according to claim 13, wherein, after said collision notification signal becomes non-active, in place of the random selection of one of said X collision processing time slots, said timing generation unit, in a case in which a re-transmission packet has an application priority higher than N/2, selects a collision processing time slot having a number larger than X/2, and, in a case in which said re-transmission packet has an application priority equal to or below N/2, selects a collision processing time slot having a number equal or below X/2.

18. The communication method according to claim 12, wherein, in place of the random selection of said collision processing time slot, the collision processing time slot selection is made to increase a probability of selection of an earlier collision processing time slot with a higher application priority.

19. The communication apparatus according to claim 13, further comprising a collision processing time slot selection unit for, after said collision notification signal becomes non-active, in place of the random selection of one of said X collision processing time slots, carrying out the collision processing time slot selection to increase a probability of selection of an earlier collision processing time slot as a re-transmission packet has a higher application priority.

20. The communication method according to claim 12, wherein, in a case in which a request for transmission of application priority=1 occurs in one communication apparatus during reception of a jam signal, even if the one communication apparatus is not involved in a collision, the one communication selects said collision processing time slot and carries out re-transmission.

21. The communication apparatus according to claim 13, further comprising a jam signal detection unit for issuing a jam detection signal during reception of a jam signal,
when a request for transmission of a packet having APP=1 takes place while said jam detection signal is active, said timing generation unit selecting one of said X collision processing time slots after said collision notification signal becomes non-active, and outputting a transmission start signal to said buffer unit at the timing of the selected time slot.

22. The communication method according to claim 12, wherein a special time slot is located between said jam signal and said collision processing time slots, and in a case in which a request for transmission of application priority=1 occurs during reception of said jam signal, even if one communication apparatus is not involved in a collision, the one communication carries out transmission from said special time slot.

23. The communication apparatus according to claim 13, further comprising a jam signal detection unit for issuing a jam detection signal during reception of a jam signal,
when a request for transmission of a packet having application priority=1 takes place while said jam detection signal is active, said timing generation unit transmitting a packet at the timing of a special time slot after said collision notification signal becomes non-active.

24. A communication method of transmitting a packet according to a carrier sense multiple access system with a collision detection function between plural communication apparatus each connected to a transmission line of a logically substantial bus type, comprising the steps of:
setting N (N represents an integer equal to or more than two) application priorities specified from the external and N physical priorities to be used at actual transmission to said transmission line where 1 signifies the highest priority and N signifies the lowest priority;
setting N priority time slots after a packet comes to an end on said transmission line where said time slots are taken as PTS1, PTS2, . . . , PTSN in latening time sequence so that a packet having a physical priority=m (1≦m≦N) has a transmission right on and after a time slot PTSm;
making one master communication apparatus carry out an observation of said application priority and physical priority of a packet flowing on said transmission line for a given period of time for seizing the correspondence between said application priority and said physical priority; and
broadcasting information on conversion from said application priority to said physical priority to another communication apparatus.

25. A communication apparatus comprising:
a transmission unit having a function to convert an inputted digital signal into a signal having a form suitable for transmission and to send out the converted signal to a transmission line;
a reception unit having a function to check whether or not a signal exists on said transmission line and to, if the signal exists thereon, issue a busy signal and receive the existing signal for converting it into a digital signal;
a priority observation unit for observing the correspondence between a physical priority and application priority of a packet flowing on said transmission line on the basis of the digital signal outputted from said reception unit;
a priority conversion unit for accumulating the results of observations by said priority observation unit at intervals of given period of time to produce/update a conversion table between a physical priority and an application priority for obtaining a corresponding physical priority on the basis of a packet application priority inputted together with transmission packet data from the external and outputting the obtained physical priority to a timing generation unit;
a buffer unit having a function to temporarily retain transmission packet data; and
a conversion information transmission unit having a function to convert information on conversion between said physical priority and said application priority into a packet data form for transferring the packet data to said buffer unit,
when a packet to be transmitted exists, the packet data being inputted to said buffer unit, and said priority conversion unit obtaining a physical priority corresponding to an application priority of said packet to notify the obtained physical priority to said timing generation unit, and if a packet comes to an end on said transmission line and said busy signal becomes non-active, said timing generation unit detecting the end of said packet and the non-active busy signal and sending a transmission start signal to said buffer unit when a timing of a priority time slot (PTS) corresponding to the physical priority notified from said priority conversion unit is reached after the time that said packet comes to an end on said transmission line, and said buffer unit sending out the retained transmission packet data to said transmission unit in response to said transmission start signal, and said conversion information transmission unit transferring the contents of a conversion table at every conversion table production/updating to said buffer unit of each of other communication apparatus in the form of a packet.

26. A communication method of transmitting packets according to a carrier sense multiple access system with a collision detection function between plural communication apparatus each connected to a transmission line of a logically substantial bus type, comprising the steps of:
setting N (N represents an integer equal to or more than two) application priorities specified from the external and N physical priorities to be used at actual transmission to the transmission line where 1 signifies the highest priority and N signifies the lowest priority;
setting N priority time slots after a packet comes to an end on the transmission line where the time slots are taken as PTS1, PTS2, . . . , PTSN in latening time sequence so that a packet having a physical priority=m (1≦m≦N) has a transmission right on and after a time slot PTSm;
making one or more slave communication apparatus receive conversion information sent from a master communication apparatus to produce a conversion table for determining a physical priority of a transmission packet in accordance with the produced conversion table; and
when an application priority of a packet to be transmitted is absent in said conversion table, transmitting said packet using a physical priority having a value equal to that of said application priority.

27. A communication apparatus comprising:
a transmission unit having a function to convert an inputted digital signal into a signal having a form suitable for transmission and to send out the converted signal to a transmission line;
a reception unit having a function to check whether or not a signal exists on said transmission line and to, if the signal exists thereon, issue a busy signal and receive the existing signal for converting it into a digital signal;
a conversion information reception unit for receiving conversion information, sent from a communication apparatus defined in claim 25, on the basis of said digital signal outputted from said reception unit,
a priority conversion unit for producing/updating a conversion table between a physical priority and an application priority on the basis of said conversion information for obtaining a corresponding physical priority on the basis of a packet application priority inputted together with transmission packet data from the external and outputting the obtained physical priority to a timing generation unit; and
a buffer unit having a function to temporarily retain transmission packet data;
when receiving a packet on said conversion information sent from the communication apparatus defined in claim 25, said conversion information reception unit writing the contents thereof over the conversion table of said priority conversion unit,
when a packet to be transmitted exists, the packet data being inputted to said buffer unit, and said priority conversion unit obtaining a physical priority corresponding to an application priority of said packet to notify the obtained physical priority to said timing generation unit,
when a packet comes to an end on said transmission line and said busy signal becomes non-active, said timing generation unit detecting the end of said packet and the non-active busy signal,
said timing generation unit sending a transmission start signal to said buffer unit when a timing of a priority time slot (PTS) corresponding to the physical priority notified from said priority conversion unit is reached after the time that said packet comes to an end on said transmission line, and
said buffer unit sending out the retained transmission packet data to said transmission unit in response to said transmission start signal.

28. A communication system comprising a first communication apparatus and one or more second communication apparatus, connected a logically bus type transmission line,
said first communication apparatus including:
a transmission unit having a function to convert an inputted digital signal into a signal having a form suitable for transmission and to send out the converted signal to a transmission line;
a reception unit having a function to check whether or not a signal exists on said transmission line and to, if the signal exists thereon, issue a busy signal and receive the existing signal for converting it into a digital signal;
a priority observation unit for observing the correspondence between a physical priority and application priority of a packet flowing on said transmission line on the basis of the digital signal outputted from said reception unit;
a priority conversion unit for accumulating the results of observations by said priority observation unit at intervals of given period of time to produce/update a conversion table between a physical priority and an application priority for obtaining a corresponding physical priority on the basis of a packet application priority inputted together with transmission packet data from the external and outputting the obtained physical priority to a timing generation unit;
a buffer unit having a function to temporarily retain transmission packet data; and
a conversion information transmission unit having a function to convert information on conversion between said physical priority and said application priority into a packet data form for transferring the packet data to said buffer unit,
when a packet to be transmitted exists, the packet data being inputted to said buffer unit, and said priority conversion unit obtaining a physical priority corresponding to an application priority of said packet to notify the obtained physical priority to said timing generation unit, and if a packet comes to an end on said transmission line and said busy signal becomes non-active, said timing generation unit detecting the end of said packet and the non-active busy signal and sending a transmission start signal to said buffer unit when a timing of a priority time slot (PTS) corresponding to the physical priority notified from said priority conversion unit is reached after the time that said packet comes to an end on said transmission line, and said buffer unit sending out the retained transmission packet data to said transmission unit in response to said transmission start signal, and said conversion information transmission unit transferring the contents of a conversion table at every conversion table production/updating to said buffer unit of each of other communication apparatus in the form of a packet, and
each of said second communication apparatus including:
a transmission unit having a function to convert an inputted digital signal into a signal having a form suitable for transmission and to send out the converted signal to a transmission line;
a reception unit having a function to check whether or not a signal exists on said transmission line and to, if the signal exists thereon, issue a busy signal and receive the existing signal for converting it into a digital signal;
a conversion information reception unit for receiving conversion information, sent from said first communication apparatus, on the basis of said digital signal outputted from said reception unit,
a priority conversion unit for producing/updating a conversion table between a physical priority and an application priority on the basis of said conversion information for obtaining a corresponding physical priority on the basis of a packet application priority inputted together with transmission packet data from the external and outputting the obtained physical priority to a timing generation unit; and
a buffer unit having a function to temporarily retain transmission packet data;
when receiving a packet on said conversion information sent from the communication apparatus defined in claim 25, said conversion information reception unit writing the contents thereof over the conversion table of said priority conversion unit,
when a packet to be transmitted exists, the packet data being inputted to said buffer unit, and said priority conversion unit obtaining a physical priority corresponding to an application priority of said packet to notify the obtained physical priority to said timing generation unit,
when a packet comes to an end on said transmission line and said busy signal becomes non-active, said timing generation unit detecting the end of said packet and the non-active busy signal,
said timing generation unit sending a transmission start signal to said buffer unit when a timing of a priority time slot (PTS) corresponding to the physical priority notified from said priority conversion unit is reached after the time that said packet comes to an end on said transmission line, and
said buffer unit sending out the retained transmission packet data to said transmission unit in response to said transmission start signal.

29. The communication method according to claim 24, wherein, as a method of producing said conversion table, in a case in which detected is the fact that packets having different application priorities with respect to one physical priority exist on said transmission line, said conversion table is immediately updated and the contents of the updated conversion table are broadcasted.

30. The communication apparatus according to claim 25, wherein, when seeing information from said priority observation unit and detecting that packets having different application priorities with respect to one physical priority exist on said transmission line, said priority conversion unit updates said conversion table immediately, and, whenever a conversion table is produced/updated, said conversion information transmission unit converts the produced/updated conversion table into a packet form, which is addressed to each of all of the other communication apparatus, with the packeted conversion table being transferred to said buffer unit.

31. The communication method according to claim 24, wherein, on the basis of long-term statistics for frequency of appearance of packets for each application priority, in a time zone in which many packets having a high application priority are expected to appear, a conversion table is produced such that a low application priority is not converted into a high physical priority.

32. The communication apparatus according to claim 25, further comprising:
a timer unit;
a traffic recording unit for recording information from said priority observation unit together with the present time given by said timer unit; and
a statistical processing unit for obtaining a frequency of use of each priority at intervals of given period of time on the basis of said information recorded by said traffic recording unit 35 to notify a time zone, in which more packets appear over a predetermined value according to application priority, to said priority conversion unit,
said priority conversion unit reserving said application priority in said time zone notified from said statistical processing unit, and producing the conversion table so that a physical priority corresponding to the reserved application priority is not assigned to a packet having an application priority lower than the reserved application priority.

33. The communication method according to claim 24, wherein, when a decision is made that collisions occur frequently, a plurality of physical priorities are assigned to an application priority producing the most traffic.

34. The communication apparatus according to claim 25, further comprising:
a collision detection unit for comparing an input signal to said transmission unit and an output signal from said reception unit to, if they do not agree with each other, make a decision that a collision occurs on said transmission line and to output a collision detection signal;
a collision frequency measurement unit for counting the number of collision detection signals issued in a unit time; and
a priority frequency measurement unit for measuring the number of packets for each application priority, flowing on said transmission line, in a unit time,
in a case in which the frequency of occurrence of collision exceeds a predetermined value, a collision frequency notification signal is generated to said priority conversion unit, and upon receipt of said collision frequency notification signal, said priority conversion unit learns an application priority, most flowing on said transmission line, from said priority frequency measurement unit, and produces a conversion table in which a plurality of successive physical priorities are assigned to said application priority.

35. The communication method according to claim 26, wherein, in the case of reception of a conversion table in which a plurality of physical priorities are assigned with respect to one application priority, for transmission of a packet having the one application priority, one of the assigned physical priorities is selected at random.

36. The communication apparatus according to claim 27, wherein, when receiving a conversion table in which a plurality of physical priorities are assigned with respect to one application priority, for transmission of a packet having said application priority, said conversion information reception unit randomly selects one of the physical priorities assigned by said priority conversion unit.

37. The communication method according to claim 1, wherein, when a packet having a low priority is transmitted, in a case in which packets having a high priority occupy said transmission line to make it difficult to carry out transmission over a given period of time, the transmission is made with a physical priority higher by one rank than a physical priority obtained from a conversion table.

38. The communication apparatus according to claim 2, further comprising a time measurement unit for starting time measurement at the time of a transmission start signal from said timing generation unit and if a packet is not actually transmitted yet when a predetermined period of time elapses, outputting a transmission delay notification signal to said timing generation unit,
on the basis of said transmission delay notification signal from said time measurement unit, said timing generation unit re-issuing a transmission timing signal as a physical priority higher by one rank than the original physical priority.

39. The communication apparatus according to claim 25, further comprising a time measurement unit for starting time measurement at the time of a transmission start signal from said timing generation unit and if a packet is not actually transmitted yet when a predetermined period of time elapses, outputting a transmission delay notification signal to said timing generation unit,
on the basis of said transmission delay notification signal from said time measurement unit, said timing generation unit re-issuing a transmission timing signal as a physical priority higher by one rank than the original physical priority.

40. The communication apparatus according to claim 27, further comprising a time measurement unit for starting time measurement at the time of a transmission start signal from said timing generation unit and if a packet is not actually transmitted yet when a predetermined period of time elapses, outputting a transmission delay notification signal to said timing generation unit,
on the basis of said transmission delay notification signal from said time measurement unit, said timing generation unit re-issuing a transmission timing signal as a physical priority higher by one rank than the original physical priority.

41. A communication method of transmitting a packet according to a carrier sense multiple access system with a collision detection function between plural communication apparatus each connected to a transmission line of a logically substantial bus type, comprising the steps of:
creating an area in a packet flowing on said transmission line to store a physical priority of said packet;
for an observation of said physical priority, writing said physical priority in said area at transmission of said packet, and reading out a value indicative of said physical priority from said area at reception of said packet;
upon detection of the occurrence of a collision of a packet transmitted onto said transmission line, outputting a jam signal to notify the occurrence of the collision to all of said communication apparatus for a given period of time; and
making re-transmission in a state where said physical priority is set to be equal to an application priority of said packet.

42. A communication method of transmitting a packet according to a carrier sense multiple access system with a collision detection function between plural communication apparatus each connected to a transmission line of a logically substantial bus type, comprising the steps of:
creating an area in a packet flowing on said transmission line to store a physical priority of said packet;
for an observation of said physical priority, writing said physical priority in said area at transmission of said packet, and reading out a value indicative of said physical priority from said area at reception of said packet;
upon detection of the occurrence of a collision of a packet transmitted onto said transmission line, outputting a jam signal for a given period of time to notify the occurrence of the collision to all of said communication apparatus;
creating X (X represents an integer equal to or more than two) collision processing time slots where said time slots are taken as CTS1, CTS2, . . . , CTSX in latening time sequence; and
making said communication apparatus involved in the collision randomly selects one of said collision processing time slots for re-transmission.

43. A communication method of transmitting a packet according to a carrier sense multiple access system with a collision detection function between plural communication apparatus each connected to a transmission line of a logically substantial bus type, comprising the steps of:
creating an area in a packet flowing on said transmission line to store a physical priority of said packet;
for an observation of said physical priority, writing said physical priority in said area at transmission of said packet, and reading out a value indicative of said physical priority from said area at reception of said packet;
upon detection of the occurrence of a collision of a packet transmitted onto said transmission line, outputting a jam signal for a given period of time to notify the occurrence of the collision to all of said communication apparatus;
creating X (X represents an integer equal to or more than two) collision processing time slots where said time slots are taken as CTS1, CTS2, . . . , CTSX in latening time sequence;
making said communication apparatus involved in the collision randomly select one of said collision processing time slots for re-transmission; and
in a case in which a request for transmission of application priority=1 occurs in one communication apparatus during reception of said jam signal, making the one communication select said collision processing time slot even if the one communication apparatus is not involved in a collision, and carry out the re-transmission.

44. A communication method of transmitting a packet according to a carrier sense multiple access system with a collision detection function between plural communication apparatus each connected to a transmission line of a logically substantial bus type, comprising the steps of:
setting N (N represents an integer equal to or more than two) application priorities specified from the external and N physical priorities to be used at actual transmission to said transmission line where 1 signifies the highest priority and N signifies the lowest priority;
setting N priority time slots after a packet comes to an end on said transmission line where said time slots are taken as PTS1, PTS2, . . . , PTSN in latening time sequence so that a packet having a physical priority=m (1≦m≦N) has a transmission right on and after a time slot PTSm;
making one master communication apparatus carry out an observation of said application priority and physical priority of a packet flowing on said transmission line for a given period of time for seizing the correspondence between said application priority and said physical priority to produce a conversion table, with an area being placed in a packet flowing on said transmission line for storing said physical priority of said packet;
for an observation of said physical priority, writing said physical priority in said area at transmission of said packet, and reading out a value indicative of said physical priority from said area at reception of said packet;
broadcasting information on conversion from said application priority to said physical priority to other communication apparatus, and in a case in which detected is the fact that packets having different application priorities with respect to one physical priority exist on said transmission line, updating said conversion table immediately and broadcasting the contents of the updated conversion table;
upon detection of the occurrence of a collision of a packet transmitted onto said transmission line, outputting a jam signal to notify the occurrence of the collision to all of said communication apparatus for a given period of time; and
making re-transmission in a state where said physical priority is set to be equal to an application priority of said packet.

45. The communication apparatus according to claim 7, further comprising:
a collision detection unit for comparing an input signal to said transmission unit with an output signal from said reception unit to, if the comparison result indicates that they do not agree with each other, making a decision to the occurrence of a collision on said transmission line and outputting a collision detection signal; and
a collision notification unit for outputting a collision notification signal which is active for a given period of time after the collision detection,
when receiving said collision detection signal, said collision notification unit sending said collision notification signal to said transmission unit,
said transmission unit outputting a jam signal to said transmission line while said collision notification signal is active, and
when receiving said collision notification signal, said priority conversion unit temporarily changing a priority conversion for a packet to be transmitted, and notifying a physical priority equal to said application priority to said timing generation unit so that a re-transmission packet is transmitted with said physical priority equal to said application priority.

46. The communication apparatus according to claim 7, further comprising:
a collision detection unit for comparing an input signal to said transmission unit with an output signal from said reception unit to, if the comparison result indicates that they do not agree with each other, making a decision to the occurrence of a collision on said transmission line and outputting a collision detection signal; and
a collision notification unit for outputting a collision notification signal which is active for a given period of time after the collision detection,
when receiving said collision detection signal, said collision notification unit sending said collision notification signal to said transmission unit and said timing generation unit,
said transmission unit outputting a jam signal to said transmission line while said collision notification signal is active, and
after said collision notification signal becomes non-active, said timing generation unit randomly selecting one of X collision processing time slots and outputting a re-transmission start signal to said buffer unit at a timing of the selected collision processing time slot.

47. The communication apparatus according to claim 46, further comprising a jam signal detection unit for issuing a jam detection signal during reception of a jam signal,
when a request for transmission of a packet having APP=1 takes place while said jam detection signal is active, said timing generation unit selecting one of said X collision processing time slots after said collision notification signal becomes non-active, and outputting a transmission start signal to said buffer unit at the timing of the selected time slot.

48. The communication apparatus according to claim 30, further comprising:
a collision detection unit for comparing an input signal to said transmission unit with an output signal from said reception unit to, if the comparison result indicates that they do not agree with each other, making a decision to the occurrence of a collision on said transmission line and outputting a collision detection signal; and
a collision notification unit for outputting a collision notification signal which is active for a given period of time after the collision detection,
said priority observation unit including physical priority readout means for reading out a physical priority from a received packet and application priority readout means for reading out an application priority from the received packet,
said physical priority readout means outputting said physical priority, read out from the received packet, to said priority conversion unit,
said application priority readout means outputting said application priority, read out from the received packet, to said priority conversion unit,
when receiving said collision detection signal, said collision notification unit notifying said collision notification signal to said transmission unit,
said transmission unit outputting a jam signal to said transmission line while said collision notification signal is active, and
when receiving said collision notification signal, said priority conversion unit temporarily changing priority conversion for a packet to be transmitted and notifying a physical priority equal to the application priority of said packet to said timing generation unit so that a re-transmission packet is transmitted with a physical priority equal to an application priority of said packet.
